(19) United States
(12) Patent Application Publication
(10) Pub. No.: US 2007/0140651 A1
(43) Pub. Date: Jun. 21, 2007

(54) RECORDING APPARATUS

(75) Inventors: Satoshi HASHIMOTO, Osaka, NJ (JP); Shigeaki WATANABE, Osaka, NJ (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/612,212

(22) Filed: Dec. 18, 2006

Related U.S. Application Data
(60) Provisional application No. 60/751,321, filed on Dec. 19, 2005.

(51) Int. Cl. H04N 5/91

(52) U.S. Cl. 386/83

(57) ABSTRACT

The broadcast recording and reproduction apparatus 1300 which limits loss of content to a minimum includes: a recording generation unit 2801 which records data included in a broadcast signal into a unit-region; a volume remainder detection unit 2813 which detects the remaining capacity, within the unit-region, that can be recorded into; a volume remainder insufficiency sensing unit 2802 which senses that the remaining capacity goes below a predetermined capacity; a remainder insufficiency handler which is called when it is sensed that the remaining capacity goes below the predetermined capacity; and a remainder insufficiency handler registration unit 3301 which registers the remainder insufficiency handler. The remainder insufficiency handler registered in the remainder insufficiency handler registration unit 3301 is called.

### CROSS REFERENCE TO RELATED APPLICATION

This application claims the benefit of U.S. Provisional Application No. 60/751,321, filed Dec. 19, 2005, the contents of which are herein incorporated by reference in its entirety.

### BACKGROUND OF THE INVENTION

(1) Field of the Invention

The present invention relates to a recording apparatus such as, for example, a recording and reproduction apparatus for viewing a content as well as recording a content and reproducing the recorded content. In particular, the present invention relates to a setup for receiving a content made up of data such as video, audio, and a program that are mutually synchronized, multiplexed with a broadcast signal, and sent, in which the broadcast signal is received and the video, audio, and data are viewed and recorded, as well as a setup for resolving an insufficiency in a capacity of a recording area for recording the content.

(2) Description of the Related Art

A broadcast signal sent from a broadcast station includes various types of contents. Aside from video and audio used in a normal TV show, there are cases where a content includes data. There are several methods for sending the data, which can be roughly divided into a method of sending the data chronologically and a method of repeatedly sending the data on a fixed-interval basis. In the former method of sending the data chronologically, for example, data that continues over the course of time is sent in sequential order. This method is suitable for sending large amounts of data over a long period of time, but there is a drawback in that data that is not received at the timing of the sending cannot be received again. On the other hand, in the later method of repeatedly sending the data on a fixed-interval basis, the same data is repeatedly sent any number of times during a fixed period. This method has an advantage in that during the period when the same data is being sent, any one of the repeatedly-sent data can be received, and thus the timing of receiving is not limited. Data broadcast, represented by BML, and file sending through DSM-CC data carousel are examples of this method. It is unknown, particularly in broadcast, when a recipient will select a channel and commence reception. In the method of sending the data chronologically, when the start of reception falls behind the timing of the sending and acquisition of data fails, the data cannot be re-acquired. Therefore, when sending data such as an application program along with video and audio in the broadcast signal, the method of repeatedly sending the data on a fixed-interval basis is favorable.

At present, specifications for receiving a broadcast signal that includes video, audio, and an application program and executing the application program in synchronization with video and audio, as in the above method, have been developed and are in operation. Aside from the normal viewing of the video and audio, it is also possible to receive the sent application program, import the application program into a terminal, and implement various extra functions by executing the application program. This method for sending the application program and importing the application program into the terminal is also called “downloading”. For example, a specification called Digital Video Broadcasting-Multimedia Home Platform (DVB-MHP) ETSIES201812 v1.1.1 (2003-12) has been developed in Europe, and operations according to this specification have already commenced. In addition, Open Cable Application Platform (OCAP) OC-SP-OCAP1.0-I14-050119 specification, which provides the same specification in the cable broadcast environment, is being developed in the United States, and actual operations are expected to commence. In these specifications, the application program is written in the Java language. Various Application Programming Interfaces (APIs) for tuning, graphics display, and the like are provided in the terminal, and the Java application program can control those functions by calling the APIs.

In addition, in North America, the OCAP-DVROC-SP-OCAP-DVR-I01-040524 specification, which is aimed at adding a function for recording and reproducing the content in the OCAP specification, is being developed. With this specification, the video, audio, and the Java application program synchronized thereto and executed, which are sent as a cable television broadcast, are recorded as the content, and furthermore, the recorded content are reproduced in the same manner as when the recorded content are directly reproduced from the broadcast signal. The application program is reproduced in synchronization with the video and audio, in the same manner as direct reproduction from the broadcast signal.

Moreover, with OCAP-DVR, trick-play of the content is realized by recording broadcast content to a high-speed randomly accessible storage medium, such as a hard disk, a semiconductor memory, and the like. Here, the trick-play refers to functions for reproducing the content at an arbitrary speed, from an arbitrary position, and so on, such as fast-forward, reverse, slow-motion, pause, skip, and the like. With OCAP-DVR, the application program imported into the terminal from the broadcast signal can control the recording and trick-play of the content. In other words, APIs for recording and trick play are provided in the terminal, and the Java application program controls each function by calling those APIs.

Normally, in order for an application program to be synchronized with the video and audio and be executed, control information for synchronization is multiplexed on the broadcast signal in advance. The application program is sequentially executed and terminated according to the synchronization control information. With this, it becomes possible to switch to and execute an appropriate application program in time with a specific scene of the video and audio.

Furthermore, with the OCAP-DVR standard, a recording area is divided and managed in units referred to as volumes. In content recording, the application program specifies a specific volume, and the content is recorded in that volume.

As described above, with the OCAP-DVR standard, a recording area is divided and managed in units referred to as volumes. In content recording, the application program specifies a specific volume, and the content is recorded in that volume. Only a volume for the capacity specified by the application program is reserved. When a content currently being recorded exceeds the capacity of the volume, specified by the application program, the recording of the content is made to stop in mid-stream.

In other words, with the conventional recording apparatus, there is the problem that the entire content cannot be recorded and loss is incurred.

However, there is a possibility that an area, which has not yet been assigned a volume, exists in the recording medium. As long as there is framework for recording content into the area, which has not yet been assigned a volume, in the recording medium, it is possible to keep lost content to a minimum even when the content currently being recorded exceeds the volume capacity specified by the application program.

Thus, the present invention is conceived in view of the aforementioned problem, and has as an object to provide a recording apparatus that minimizes content loss.

### SUMMARY OF THE INVENTION

In order to achieve the aforementioned object, the recording apparatus according to the present invention is a recording apparatus that records data included in a broadcast signal, the recording apparatus including: a recording generation unit which records the data included in the broadcast signal into a unit-region, the unit-region being a predetermined capacity within a recording area; a volume remainder detection unit which detects a remaining capacity available for recording in the unit-region; a volume remainder insufficiency sensing unit which senses that the remaining capacity available for recording in the unit-region is below a predetermined capacity, the remaining capacity being detected by the volume remainder detection unit; a remainder insufficiency handler which is called when the volume remainder insufficiency sensing unit senses that the remaining capacity available for recording in the unit-region being used for the recording, is below the predetermined capacity; and a remainder insufficiency handler registration unit which registers the remainder insufficiency handler, wherein the remainder insufficiency handler registered in the remainder insufficiency handler registration unit is called when the volume remainder insufficiency sensing unit senses that the remaining capacity available for recording in the unit-region is below the predetermined capacity.

Accordingly, since the registered remainder insufficiency handler is called when, during broadcast signal recording, it is sensed that the remaining capacity of the unit-region for recording the broadcast signal is insufficient, the handling of the insufficiency can be entrusted to the remainder insufficiency handler, and a more flexible response can be executed. As a result, it becomes possible to minimize the loss of content.

Furthermore, in order to achieve the aforementioned object, the recording apparatus according to the present invention is a recording apparatus that records data included in a broadcast signal, the recording apparatus including: a recording generation unit which records the data included in the broadcast signal into a unit-region for a specific period of time, the unit-region being a predetermined capacity within a recording area; a volume remainder detection unit which detects a remaining capacity available for recording in the unit-region; a volume remainder insufficiency sensing unit which senses that the remaining capacity available for recording in the unit-region is below a minimum capacity necessary for recording the broadcast signal for the specific period of time, the remaining capacity being detected by the volume remainder detection unit; and a supplementary volume generation unit which generates a new unit-region within the recording area, and records the data included in the broadcast signal into the new unit-region.

Accordingly, when, during broadcast signal recording, it is sensed that the remaining capacity of the unit-region for recording the broadcast signal is insufficient, a supplementary unit-region is generated in a surplus portion of the recording area, and the portion of the broadcast signal that cannot be recorded into the unit-region is recorded in the supplementary unit-region. Therefore, the surplus portion of the recording area can be fully utilized and the recording of the broadcast signal can be completed. As a result, it becomes possible to minimize the loss of content.

Note that the present invention can be implemented, not only as the above-mentioned recording apparatus, but also as a content reproduction method carried out by the recording apparatus, a program for carrying out the recording by the recording apparatus, and a storage medium for storing the program.

As further information about technical background to this application, the disclosure of U.S. Provisional Application No. 60/751,321 filed Dec. 19, 2005, including specification, drawings and claims, is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcast system according to the present invention;

FIG. 2 is a diagram showing an example of the usage of a frequency band used in communications between a broadcast station side system and a terminal apparatus, in a cable television system according to the present invention;

FIG. 3 is a diagram showing an example of the usage of a frequency band used in communications between a broadcast station side system and a terminal apparatus, in a cable television system according to the present invention;

FIG. 4 is a diagram showing an example of the usage of a frequency band used in communications between a broadcast station side system and a terminal apparatus, in a cable television system according to the present invention;

FIG. 5 is a configuration diagram of a TS packet predefined by MPEG-2 specifications;

FIG. 6 is a schematic diagram of an MPEG-2 transport stream;

FIG. 7 is a diagram showing an example of division when a PES packet predefined by MPEG-2 specifications is transmitted using a TS packet;

FIG. 8 is a diagram showing an example of division when an MPEG-2 section predefined by MPEG-2 specifications is transmitted using a TS packet;

FIG. 9 is a configuration diagram of an MPEG-2 section predefined by MPEG-2 specifications;

FIG. 10 is an example of use of an MPEG-2 section predefined by MPEG-2 specifications;

FIG. 11 is a diagram showing an example of use of a PMT predefined by MPEG-2 specifications;

FIG. 12 is a diagram showing an example of use of a PAT predefined by MPEG-2 specifications;

FIG. 13 is a configuration example of a hardware configuration of a broadcast recording and reproduction apparatus according to the present invention;

FIG. 14 is a diagram showing an example of a front panel of an input unit 1310 in a hardware configuration of a terminal apparatus 1200 according to the present invention;

FIG. 15 is a diagram showing an example of a device connection at the time of recording, in the recording and reproduction apparatus according to the present invention;

FIG. 16 is a diagram showing an example of a device connection at the time of reproduction, in the recording and reproduction apparatus according to the present invention;

FIG. 17 is a diagram showing a diagram showing a structure of the program stored in a terminal apparatus according to the present invention;

FIG. 18 is a diagram showing an example of an EPG executed by a terminal apparatus according to the present invention;

FIG. 19 is a diagram showing an example of an EPG executed by a terminal apparatus according to the present invention;

FIG. 20 is a diagram showing an example of information stored in the secondary storage unit according to the present invention;

FIG. 21 is a diagram showing an example of a recording information management table according to the present invention;

FIG. 22 is a schematic diagram showing details of AIT prescribed by the DVB-MHP standard according to the present invention;

FIG. 23 is a schematic diagram showing a file system sent in DSM-CC format according to the present invention;

FIG. 24 is a diagram showing an example of a device connection at the time of recording, in the recording and reproduction apparatus according to the present invention;

FIG. 25 is a diagram showing an example of a device connection at the time of reproduction, in the recording and reproduction apparatus according to the present invention;

FIG. 26 is a diagram showing an example of a recording information management table according to the present invention;

FIG. 27 is a schematic diagram representing the relationship between storage and volume;

FIG. 28 is a diagram showing an example of the configuration of the recording manager and the storage manager according to the present invention;

FIG. 29 is a diagram showing an example of a media information management table according to the present invention;

FIG. 30 is a flowchart for the generation of a requested volume by the volume generation unit according to the present invention;

FIG. 31 is a flowchart for the generation of a requested supplementary recording by the recording generation unit according to the present invention;

FIG. 32 is a flowchart for the generation of a requested volume by the volume generation unit according to the present invention;

FIG. 33 is a diagram showing an example of the configuration of the recording manager and the storage manager according to the present invention;

FIG. 34 is a flowchart for the registration of a remainder insufficiency handler in the remainder insufficiency handler registration unit according to the present invention;

FIG. 35 is a flowchart for the calling of a remainder insufficiency handler in the remainder insufficiency handler registration unit according to the present invention;

FIG. 36 is a flowchart for the termination of service recording by the remainder insufficiency handler according to the present invention;

FIG. 37 is a flowchart for the correction (adjustment) of service recording by the remainder insufficiency handler according to the present invention;

FIG. 38 is a flowchart for the correction (adjustment) of the bit rate for the recording of a service, by the remainder insufficiency handler according to the present invention;

FIG. 39 is a flowchart for the transfer of service recording to a generated volume, by the remainder insufficiency handler according to the present invention; and

FIG. 40 is a diagram showing an example of the configuration of the recording manager and the storage manager according to the present invention.

### DESCRIPTION OF THE PREFERRED EMBODIMENT(S)

The present invention includes the characteristics indicated hereafter.

The first invention is a recording and reproduction apparatus that records a broadcast signal as well as reproduces the recorded broadcast signal, the apparatus including: a recording generation unit which records a specific broadcast signal within a specific unit of a recording area; a volume generation unit which generates a unit in the recording area; a volume remainder detection unit which detects a remaining capacity in the specific unit of the recording area, within which the broadcast signal can be recorded; a volume remainder insufficiency sensing unit which senses that the specific unit is insufficient for recording the specific broadcast signal, by comparing a capacity required for recording the specific broadcast signal and the remaining capacity in the specific unit within which the broadcast signal can be recorded, the remaining capacity being obtained from the volume remainder detection unit; and a supplementary volume generation unit which requests the volume generation unit to generate an other unit in addition to the specific unit, and requests the recording generation unit to transfer the recording of the specific broadcast signal to within the other unit, in the case where the volume remainder insufficiency sensing unit senses that the specific unit is insufficient for recording the specific broadcast signal.

According to the aforementioned first invention, when, during the recording of a broadcast signal, an insufficiency in the remaining capacity of the unit for recording the broadcast signal is sensed, a supplementary unit is generated in the surplus portion of the storage, and the portion of the service that cannot be recorded in the unit is recorded in the supplementary unit. Therefore, it becomes possible to utilize the surplus portion of the storage and complete the recording of the broadcast signal.

The second invention is a recording and reproduction apparatus that records a broadcast signal as well as reproduces the recorded broadcast signal, the apparatus including: a recording generation unit which records a specific broadcast signal within a specific unit of a recording area; a volume remainder detection unit which detects a remaining capacity in the specific unit of the recording area, within which the broadcast signal can be recorded; a volume remainder insufficiency sensing unit which senses that the specific unit is insufficient for recording the specific broadcast signal, by comparing a capacity required for recording the specific broadcast signal and the remaining capacity in the specific unit within which the broadcast signal can be recorded, the remaining capacity being obtained from the volume remainder detection unit; and a remainder insufficient handler registration unit which calls a registered handler, in the case where the volume remainder insufficiency sensing unit senses that the specific unit is insufficient for recording the specific broadcast signal.

According to the aforementioned second invention, when, during the recording of a broadcast signal, an insufficiency in the remaining capacity of the unit for recording the broadcast signal is sensed, a registered remainder insufficiency handler is called. Therefore, responding to the insufficiency can be entrusted to the remainder insufficiency handler, and thus it becomes possible to execute more flexible response.

The third invention is an invention that is dependent on the second invention, wherein the remainder insufficient handler registration unit changes subsequent processing, depending on a result returned by the registered handler.

According to the aforementioned third invention, when, during the recording of a broadcast signal, an insufficiency in the remaining capacity of the unit for recording the broadcast signal is sensed, a registered remainder insufficiency handler is called, and the response to the insufficiency in the remaining capacity of the volume changes depending on the returned value of the remainder insufficiency handler. Therefore, it becomes possible for the remainder insufficiency handler to select and execute a predetermined response, according to such returned value.

The fourth invention is a recording and reproduction method for recording a broadcast signal as well as reproducing the recorded broadcast signal, the method including: a recording generation step of recording a specific broadcast signal within a specific unit of a recording area; a volume generation step of generating a unit in the recording area; a volume remainder detection step of detecting a remaining capacity in the specific unit of the recording area, within which the broadcast signal can be recorded; a volume remainder insufficiency sensing step of sensing that the specific unit is insufficient for recording the specific broadcast signal, by comparing a capacity required for recording the specific broadcast signal and the remaining capacity in the specific unit within which the broadcast signal can be recorded, the remaining capacity being obtained in the volume remainder detection step; and a supplementary volume generation step of requesting generation, in the volume generation step, of an other unit in addition to the specific unit, and requesting the recording generation unit to transfer the recording of the specific broadcast signal to within the other unit, in the case where, in the volume remainder insufficiency sensing step, it is sensed that the specific unit is insufficient for recording the specific broadcast signal.

According to the aforementioned fourth invention, when, during the recording of a broadcast signal, an insufficiency in the remaining capacity of the unit for recording the broadcast signal is sensed, a supplementary unit is generated in the surplus portion of the storage, and the portion of the service that cannot be recorded in the unit is recorded in the supplementary unit. Therefore, it becomes possible to utilize the surplus portion of the storage and complete the recording of the broadcast signal.

The fifth invention is a recording and reproduction method for recording a broadcast signal as well as reproducing the recorded broadcast signal, the method includes: a recording generation step of recording a specific broadcast signal within a specific unit of a recording area; a volume remainder detection step of detecting a remaining capacity in the specific unit of the recording area within which the broadcast signal can be recorded; a volume remainder insufficiency sensing step of sensing that the specific unit is insufficient for recording the specific broadcast signal, by comparing a capacity required for recording the specific broadcast signal and the remaining capacity in the specific unit within which the broadcast signal can be recorded, the remaining capacity being obtained in the volume remainder detection step; and a remainder insufficient handler registration step of calling a registered handler, in the case where, in the volume remainder insufficiency sensing step, it is sensed that the specific unit is insufficient for recording the specific broadcast signal.

According to the aforementioned fifth invention, when, during the recording of a broadcast signal, an insufficiency in the remaining capacity of the unit for recording the broadcast signal is sensed, a registered remainder insufficiency handler is called. Therefore, responding to the insufficiency can be entrusted to the remainder insufficiency handler, and thus it becomes possible to execute more flexible response.

The sixth invention is an invention that is dependent on the fifth invention, wherein the remainder insufficient handler registration step includes changing subsequent processing, depending on a result returned by the registered handler.

According to the aforementioned sixth invention, when, during the recording of a broadcast signal, an insufficiency in the remaining capacity of the unit for recording the broadcast signal is sensed, a registered remainder insufficiency handler is called, and responding to the insufficiency in the remaining capacity of the volume changes depending on the returned value of the remainder insufficiency handler. Therefore, it becomes possible for the remainder insufficiency handler to select and execute a predetermined response, according to such returned value.

### First Embodiment

Hereafter, an apparatus and a method according to the first embodiment of the present invention are described with reference to the drawings. The present invention is aimed at recording and reproduction of a content sent and received using an arbitrary medium; however, in the present embodiment, a cable television broadcast system is described as an example of an embodiment. In the cable television broadcast system, a broadcast recording and reproduction apparatus, as in the present invention, is generally called a terminal apparatus.

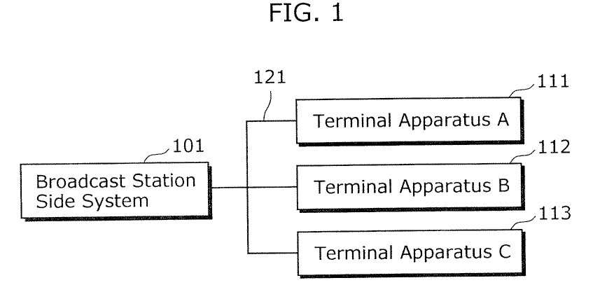

FIG. 1 is a block diagram showing a relationship of apparatuses that make up a broadcast system; the broadcast system is made up of a broadcast station side system 101, and three recording apparatuses or recording and reproduction apparatuses, namely, a terminal apparatus A111, a terminal apparatus B112, and a terminal apparatus C113. A coupling 121 between the broadcast station side system and each terminal apparatus is, in the cable system, a wired coupling such as a coaxial cable, a fiber-optic cable, and the like. In FIG. 1, one broadcast station side system is coupled with three terminal apparatuses; however, the number of terminal apparatuses is arbitrary.

The broadcast station side system 101 sends information such as video/audio/data for data broadcast in a broadcast signal to a plurality of terminal apparatuses. The broadcast signal is sent using a frequency within a frequency band set by operational regulations of the broadcast system, the laws of a country/region in which the broadcast system is operated, and so on.

With the cable system in the present embodiment, the frequency band used in broadcast signal transmission is divided, and assigned, according to data details and transmission direction (inbound, outbound).

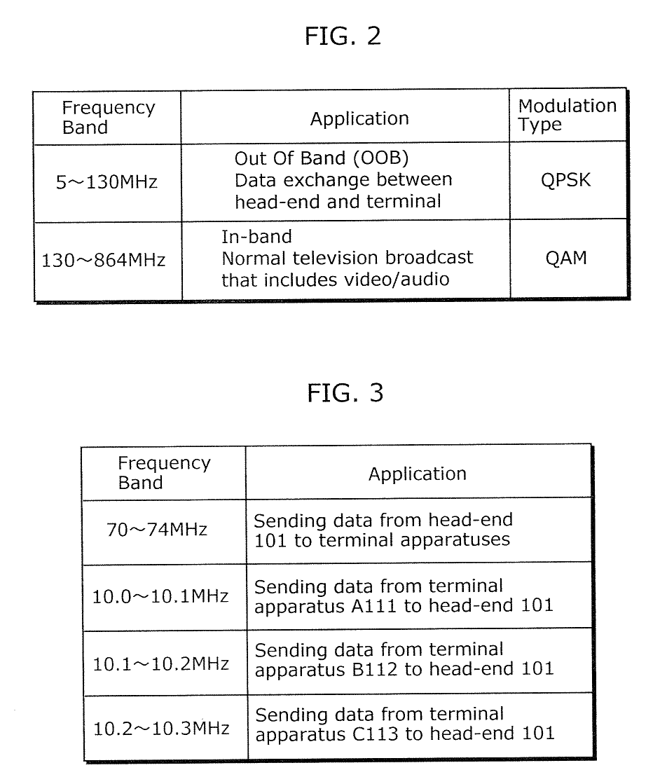

FIG. 2 is a chart showing an example of the division of the frequency band. The frequency band is roughly divided into two types: Out Of Band (abbr. OOB) and In-Band. 5 MHz to 130 MHz is assigned as OOB, and is mainly used in data exchange between the broadcast station side system 101 and the terminal apparatus A111, the terminal apparatus B112, and the terminal apparatus C113. 130 MHz to 864 MHz is assigned as In-Band, and is mainly used in an outbound-only broadcast channel that includes video/audio. QPSK modulation format is used with OOB, and QAM64 or QAM256 modulation format is used with In-Band. Modulation format technology is generally known and of little concern to the present invention, and therefore detailed description is omitted.

FIG. 3 is an example of a more detailed use of the OOB frequency band. 70 MHz to 74 MHz is used in outbound data sending from the broadcast station side system 101, and all of the terminal apparatus A111, the terminal apparatus B112, and the terminal apparatus C113 receive the same data from the broadcast station side system 101. On the other hand, 10.0 MHz to 10.1 MHz is used in inbound data sending from the terminal apparatus A111 to the broadcast station side system 101; 10.1 MHz to 10.2 MHz is used in inbound data sending from the terminal apparatus B112 to the broadcast station side system 101; and 10.2 MHz to 10.3 MHz is used in inbound data sending from the terminal apparatus C113 to the broadcast station side system 101. Through this, it is possible to independently send data unique to each terminal apparatus from each terminal apparatus A111, B112, and C113 to the broadcast station side system 101.

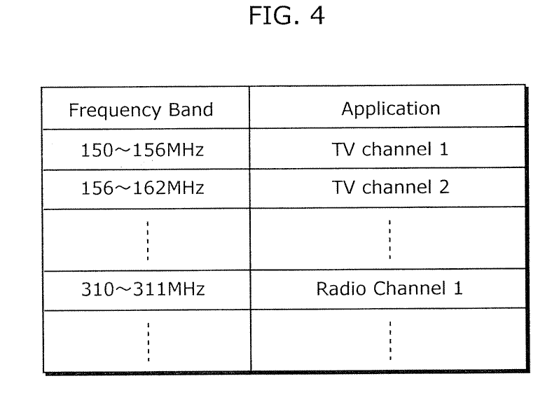

FIG. 4 is an example of use of an In-Band frequency band. 150 MHz to 156 MHz and 156 MHz to 162 MHz are assigned to a TV channel 1 and a TV channel 2 respectively, and thereafter, TV channels are assigned at 6 MHz intervals. Radio channels are assigned in 1 MHz units from 310 MHz on. Each of these channels may be used as analog broadcast or as digital broadcast. Digital broadcast is sent in TS packet format under MPEG-2 specifications, and it is also possible to send data for various data broadcast and TV show composition information for configuring an EPG, in addition to audio and video.

The broadcast station side system 101 uses the frequency bands described above to send an appropriate broadcast signal to the terminal apparatuses, and therefore has a QPSK modulation unit, a QAM modulation unit, and so on. In addition, the broadcast station side system 101 has a QPSK demodulator for receiving data from the terminal apparatuses. Moreover, the broadcast station side system 101 can be thought of as having various devices related to the modulation units and the demodulation unit. However, the present invention relates mainly to the terminal apparatuses, and therefore detailed descriptions are omitted.

On the other hand, the terminal apparatuses A111, B112, and C113 have a QAM demodulation unit and a QPSK demodulation unit in order to receive and reproduce a broadcast signal from the broadcast station side system 101. In addition, each terminal apparatus has a QSPK modulation unit in order to send data, which is unique to each terminal apparatus, to the broadcast station side system 101. In the present invention, the terminal apparatuses are broadcast recording and reproduction apparatuses, and detailed configurations are described later.

The broadcast station side system 101 modulates an MPEG-2 transport stream and transmits the stream within the broadcast signal. A terminal apparatus receives the broadcast signal, demodulates and reproduces the MPEG-2 transport stream, and from the stream, extracts and uses necessary information. In order to describe a device function and connection structure present in the terminal apparatus, the structure of the MPEG-2 transport stream is first described in a simple manner.

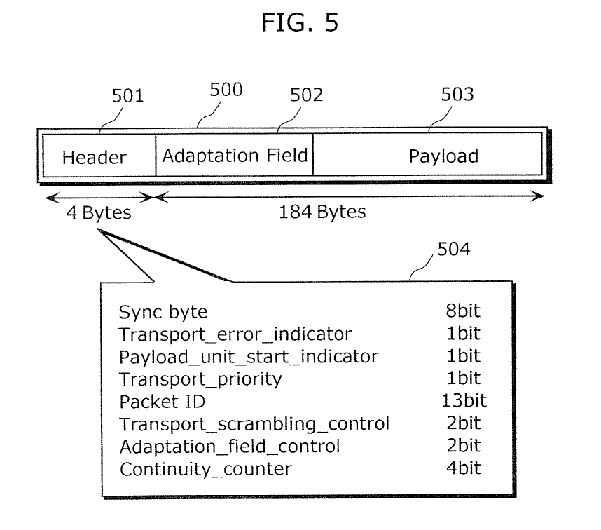

FIG. 5 is a diagram showing the structure of a TS packet. A TS packet 500 has a length of 188 bytes, and is composed of a header 501, an adaptation field 502, and a payload 503. The header 501 holds TS packet control information. It has a length of 4 bytes and the configuration shown in 504. In the header 501 there is a field denoted as “Packet ID” (hereafter, PID), and the TS packet is identified through the value of this PID. The adaptation field 502 holds additional information such as time information. The adaptation field 502 is not prerequisite, and there are cases where the adaptation field 502 is not present. The payload 503 holds information transmitted by the TS packet, such as video, audio, and data broadcast data.

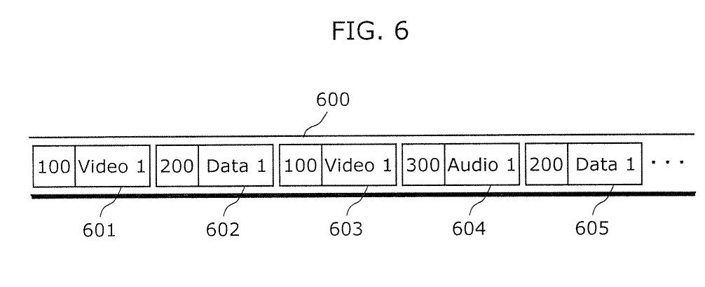

FIG. 6 is a schematic diagram of an MPEG-2 transport stream. The TS packet holds various information in the payload, such as video, audio, data used for data broadcast, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload. A TS packet 604 holds a PID 300 in the header, and holds information regarding audio 1 in the payload. Mixing TS packets which hold various types of data in the payloads and transmitting these as a series in sequence is called multiplexing. An MPEG-2 transport stream 600 is an example of a configuration in which the TS packets 601 to 605 are multiplexed.

TS packets that have identical PIDs hold identical types of information. As such, the terminal apparatus can reproduce video and audio, and reproduce data such as TV show composition information, by receiving multiplexed TS packets and extracting, per PID, the information that the TS packet holds. In FIG. 6, the TS packet 601 and the TS packet 603 each transmit information regarding the video 1, and the TS packet 602 and the TS packet 605 each transmit information regarding the data 1.

Here, description is given regarding a format of each type of data contained in the payload. Video and audio are expressed by a format called a Packetized Elementary Stream (PES) packet. The PES packet includes video information or audio information of a certain time period, and by receiving the PES packet, the broadcast recording and reproduction apparatus can output the video and audio information contained in that PES packet to a screen and speaker. The broadcast station transmits the PES packets without pause, and therefore it is possible for the broadcast recording and reproduction apparatus to continuously reproduce the video and audio without pause. When the PES packet is actually transmitted, the PES packet is divided and stored in the payloads of a plurality of TS packets in the case where the PES packet has a size larger than the payload of one TS packet.

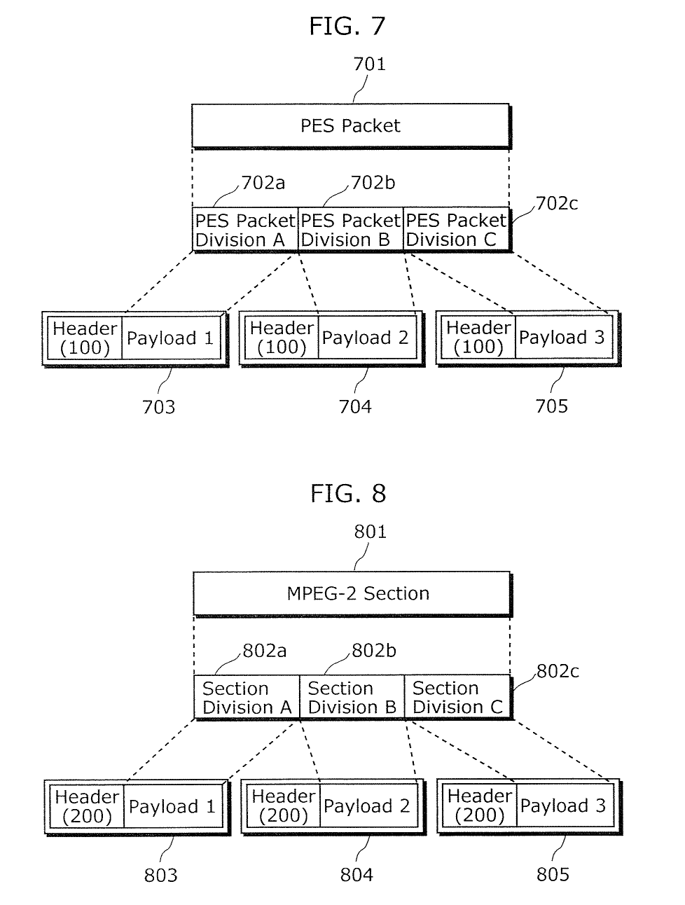

FIG. 7 shows an example of division when a PES packet is transmitted. A PES packet 701 is too large to be stored and transmitted in a payload of a single TS packet, and therefore the PES packet 701 is divided into a PES packet division A 702a, a PES packet division B 702b, and a PES packet division C 702c, and is transmitted by three TS packets 703 to 705 which have identical PIDs. In actuality, the video and audio is obtained as an elementary stream (ES) that is obtained by linking data contained in the payloads of a plurality of PES packets. The format of this elementary stream is digitalized video and audio, such as defined by the MPEG-2 Video standard, the MPEG-1 and 2 Audio standard, and the like.

On the other hand, information such as the TV show composition information and data used for data broadcast is expressed using a format called an MPEG-2 section. When the MPEG-2 section is actually transmitted, the MPEG-2 section is divided and stored in the payloads of a plurality of TS packets in the case where the MPEG-2 section has a size larger than the payload of one TS packet.

FIG. 8 shows an example of division when the MPEG-2 section is transmitted. As an MPEG-2 section 801 is too large to be stored and transmitted in a payload of a single TS packet, the MPEG-2 section 801 is divided into a section division A 802a, a section division B 802b, and a section division C 802c, and is transmitted by three TS packets 803 to 805 which have identical PIDs.

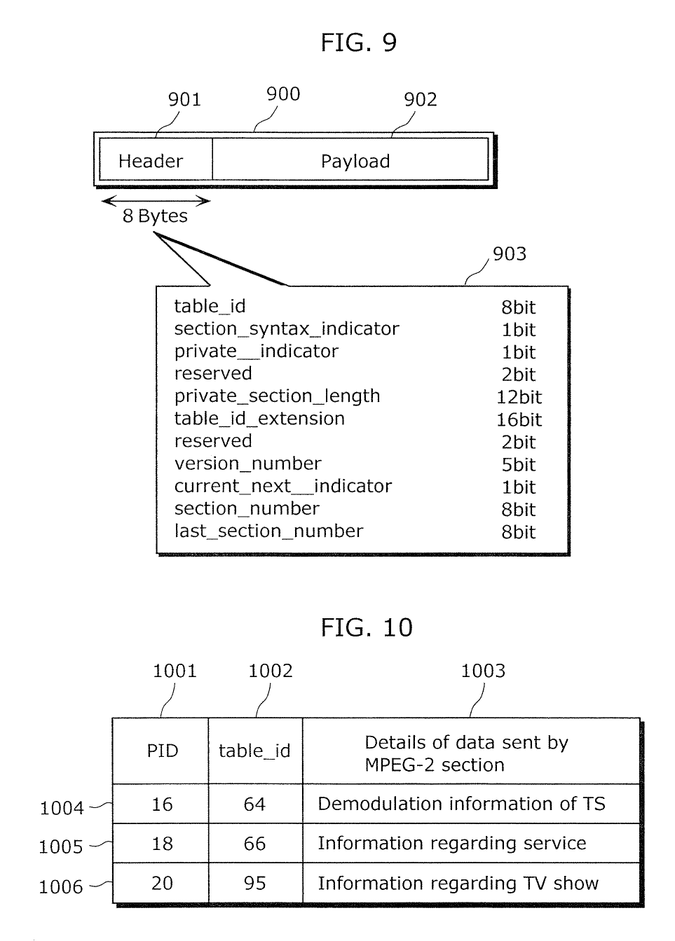

FIG. 9 expresses a structure of the MPEG-2 section. An MPEG-2 section 900 is configured of a header 901 and a payload 902. The header 901 holds control information of the MPEG-2 section. That configuration is expressed by a header configuration 903. The payload 902 holds data transmitted by the MPEG-2 section 900. A table_id present in the header configuration 903 expresses the type of the MPEG-2 section, and a table_id_extension is an extension identifier used when further distinguishing between MPEG-2 sections with an identical table_id.

The case where the TV show composition information is transmitted, as in FIG. 10, can be given as an example of use of the MPEG-2 section. In this example, as written in a row 1004, information necessary for demodulation of the broadcast signal is written in the MPEG-2 section that has a table_id of 64 in the header configuration 903, and this MPEG-2 section is further transmitted by a TS packet with a PID of 16 assigned.

The PES format does not exist in the case of the MPEG-2 section. For that reason, the elementary stream (ES) is the linkage of the payloads of TS packets identified by identical PIDs within the MPEG-2 transport stream. For example, in FIG. 8, the TS packets 803 to 805, in which the MPEG-2 section 801 is divided and transmitted, all are identified with the PID of 200. It can be said that this is an ES which transmits the MPEG-2 section 801.

A concept called a program further exists in the MPEG-2 transport stream. The program is expressed as a collection of ESs, and is used in the case where handling a plurality of ESs all together is desirable. When the program is used, it is possible to handle video/audio, as well as accompanying data broadcast data, all together. For example, in the case of simultaneously handling the video/audio to be reproduced at the same time, by grouping the video ES and the audio ES as a program, it can be seen that the broadcast recording and reproduction apparatus should simultaneously reproduce these two ESs as one TV show.

To express the program, two tables, called a Program Map Table (PMT) and a Program Association Table (PAT), are used in MPEG-2. Detailed descriptions can be found in the specifications of ISO/IEC 13818-1, “MPEG-2 Systems”. The PMT and the PAT are briefly described hereafter.

The PMT is a table included in the MPEG-2 transport stream, in the same number as there are programs. The PMT is configured as an MPEG-2 section, and has a table_id of 2. The PMT holds a program number used in identifying the program and additional information of the program, as well as information regarding an ES belonging to the program.

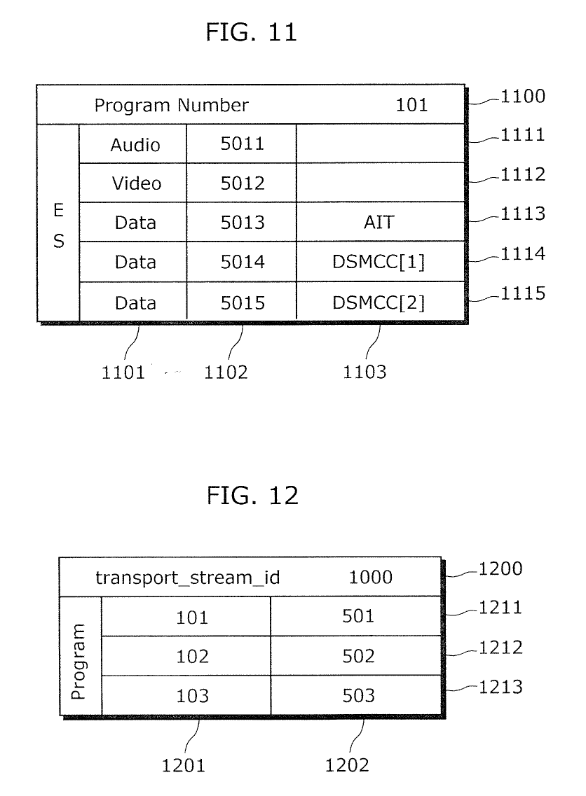

An example of the PMT is given in FIG. 11. 1100 is a program number. The program number is assigned uniquely to programs in the same transport stream, and is used in identifying the PMT. Rows 1111 to 1114 express information regarding individual ESs. A column 1101 is a type of ES, in which “video”, “audio”, “data”, and so on are specified. A column 1102 is the PID of the TS packets that make up the ES. A column 1103 is additional information regarding the ES. For example, the ES shown in row 1111 is an audio ES, and is transmitted by TS packets with a PID of 5011.

The PAT is a table, of which only one is present, in the MPEG-2 transport stream. The PAT is configured as an MPEG-2 section, has a table_id of 0, and is transmitted by a TS packet with a PID of 0. The PAT holds a transport_stream_id used in identification of the MPEG-2 transport stream, and information regarding all PMTs that represent a program existing in the MPEG-2 transport stream.

An example of the PAT is given in FIG. 12. 1200 is a transport stream_id. The transport_stream_id is used in identifying the MPEG-2 transport stream. Rows 1211 to 1213 express information regarding the program. A column 1201 is the program number. A column 1202 is the PID of the TS packet which sends the PMT that corresponds to the program. For example, the PMT of the program shown in row 1211 has a program number of 101, and the corresponding PMT is transmitted by the TS packet with a PID of 501.

In the case where the terminal apparatus reproduces a certain program, the terminal apparatus uses the PAT and the PMT and specifies the video and audio that make up a program, and reproduces that video and audio.

For example, in regards to the MPEG-2 transport stream that transmits the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from a TS packet with a PID of “0”. The PAT is searched for a program with the program number “101”, and row 1211 is obtained. From row 1211, the PID “501”, of the TS packet which transmits the PMT of the program with a program number “101”, is obtained. Next, the PMT transmitted as the MPEG-2 section with a table_id of “2” is acquired from the TS packet with the PID of “501”. Row 1111, which is audio ES information, and row 1112, which is video ES information, are obtained from the PMT. A PID “5011” of the TS packet which transmits the audio ES is obtained from row 1111. In addition, a PID “5012” of the TS packet which transmits the video ES is obtained from row 1112. Next, an audio PES packet is acquired from the TS packet with a PID “5011”, and a video PES packet is acquired from the TS packet with a PID of “5012”. Through this, it is possible to acquire the video and audio ES packets to be reproduced, and the video and audio that make up the program number 101 can be reproduced.

Note that there are cases where the MPEG-2 transport stream is scrambled. This is a setup called conditional access system. For example, by scrambling the PES packets which carry a certain video and audio, only specified viewers who can descramble them are able to view that video and audio. In order to descramble and view the video and audio, a viewer must descramble them using a device called a descrambler. For example, in an OCAP-compatible terminal apparatus, a card-type adapter with an internal descrambler is used. A cable television operator distributes, to each viewer, an adapter set to be able to descramble a specified program, and the viewer inserts that adapter into the terminal apparatus. Upon doing so, the adapter descrambles the specified program based on descrambling information such as a descrambling key and contract information of each contract holder. The method of descrambling, the method of obtaining the descrambling key, and the like are dependent on the adapter, and have no influence on the implementation of the present invention.

Thus far, simple descriptions regarding the MPEG-2 specifications have been given; hereafter, detailed definitions of terminology are given. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program”. Furthermore, concerning the latter, a “program” particularly written in the Java language is called a “Java program”.

Description has been given regarding several kinds of general information specified in the MPEG-2 specifications according to the present invention. Hereafter, the broadcast recording and reproduction terminal used in the present embodiment is described in detail.

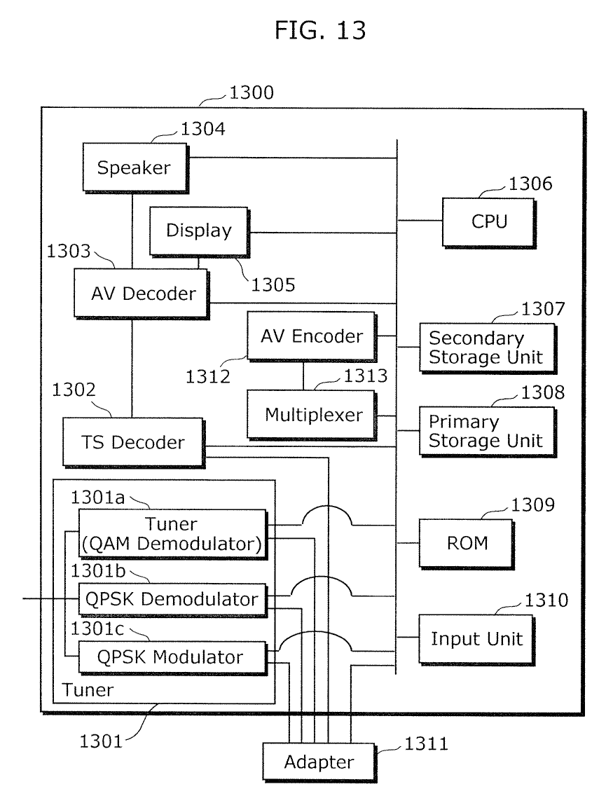

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is the broadcast recording and reproduction apparatus which is a recording apparatus or a recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; and a multiplexer (MPEG-2 Transport Stream Multiplexer or the like) 1313. Note that the present embodiment is obtained by expanding a broadcast recording and reproduction terminal implemented by the OCAP-DVR specification, and the specific hardware configuration is nearly identical to that required by the OCAP-DVR specification.

The tuner 1301 is a device which demodulates a broadcast signal modulated and transmitted from the broadcast station side system 101, in accordance with tuning information such as a frequency prescribed by the CPU 1306. Here, the tuning information is information that can identify a frequency, a modulation format, and the like. An MPEG-2 transport stream obtained as a result of demodulation by the tuner 1301 is sent to the TS decoder 1302 via the adapter 1311 which has a descrambling function.

The TS decoder 1302 is a device which has a function to segregate PES packets and MPEG-2 sections which comply with specified conditions from the MPEG-2 transport stream, based on a PID, a section filter condition, and so on prescribed by the CPU 1306. In the case where a broadcast is received and a service is reproduced without recording, the MPEG-2 transport stream which the adapter 1311 outputs is inputted to the TS decoder 1302. On the other hand, in the case of reproducing a service stored in the secondary storage unit 1307, the MPEG-2 transport stream which the secondary storage unit 1307 outputs is inputted to the TS decoder 1302. The input to be received is controlled by the CPU 1306.

The PES packets of the video and audio segregated by the TS decoder 1302 are outputted to the AV decoder 1303. In addition, the MPEG-2 section segregated by the TS decoder 1302 is transmitted to the primary storage unit 1308 through Direct Memory Access (DMA), and is used by a program executed by the CPU 1306.

The AV decoder 1303 is a device with a function to decode the encoded video ES and audio ES. The AV decoder fetches the ES from the PES packet that transmits the audio and video information sent from the TS decoder, and decodes the ES. An audio signal and a video signal obtained through the decoding performed by the AV decoder 1303 are sent to the speaker 1304 and the display 1305 at the time of service reproduction, but are sent to the AV encoder 1312 at the time of service recording. The output route to take is controlled by the CPU 1306, according to an instruction from the user.

The speaker 1304 reproduces audio outputted from the AV decoder 1303.

The display 1305 reproduces video outputted from the AV decoder 1303.

The CPU 1306 executes a program that operates in the broadcast recording and reproduction apparatus. The CPU 1306 executes a program contained in the ROM 1309. Or, the CPU 1306 executes a program downloaded from a broadcast signal or a network and held in the primary storage unit 1308. Or, the CPU 1306 executes a program downloaded from a broadcast signal or a network and held in the secondary storage unit 1307. Then the CPU 1306 controls the tuner 1301, TS decoder 1302, AV decoder 1303, speaker 1304, display 1305, secondary storage unit 1307, primary storage unit 1308, ROM 1309, and input unit 1310, in accordance with the instructions of the executed program. In addition, aside from devices present within the terminal apparatus 1300, the CPU 1306 may also communicate with the devices within the adapter 1311 and control the adapter 1311.

The secondary storage unit 1307 is a memory apparatus, the memory of which is not deleted even if the power supply to the device is interrupted. The secondary storage unit 1307 is configured of a device where information is not deleted even when the power to the terminal apparatus 1300 is turned off; for example, a nonvolatile memory such as a FLASH-ROM, a Hard Disk Drive (HDD), a rewritable media such as a CD-R and a DVD-R. The secondary storage unit 1307 saves information based on an instruction from the CPU 1306.

The primary storage unit 1308 is a device which has a function for temporarily saving information in accordance with an instruction from the CPU 1306, a DMA transfer-capable device, and so on, and is configured of a RAM or the like.

The ROM 1309 is a non-rewritable memory device, and to be more specific, is configured of a ROM, a CD-ROM, a DVD, and the like. The program which the CPU 1306 executes is stored in the ROM 1309.

The input unit 1310 is, to be more specific, configured of a front panel or a remote control, and accepts an input from the user.

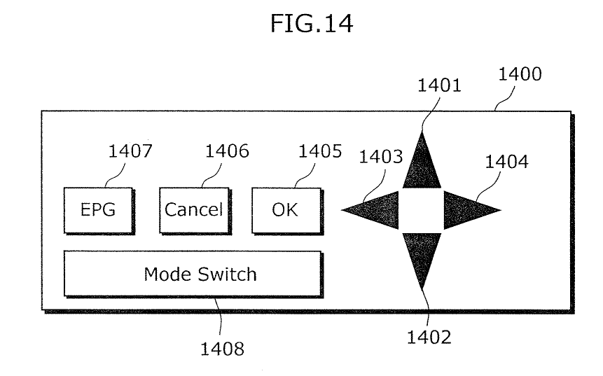

FIG. 14 is an example of a case where the input unit 1310 is configured of the front panel. A front panel 1400 has seven buttons: an up cursor button 1401, a down cursor button 1402, a left cursor button 1403, a right cursor button 1404, an OK button 1405, a cancel button 1406, an EPG button 1407, and a mode switch button 1408. When a user presses a button, an identifier of the pressed button is notified to the CPU 1306.

The adapter 1311 is a device for descrambling a scrambled MPEG-2 transport stream carried in the In-band frequency range, and includes one or more descramblers. The MPEG-2 transport stream outputted by the tuner 1301a is inputted into the adapter 1311, and cryptograph removal is carried out on the TS packet that has the PID specified by the CPU 1306. The adapter 1311 outputs the descrambled MPEG-2 transport stream to the TS decoder 1302.

Furthermore, the adapter 1311 carries out format conversion of data sent in an OOB frequency range. Information that is sent OOB is modulated in the QPSK modulation format. Regarding outbound transmission, the QPSK demodulator 1301b demodulates the outbound signal sent from the broadcast station side system 101, and inputs a generated bit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, with regard to inbound transmission, the CPU 1306 inputs information to be sent to the broadcast station side system 101 into the adapter 1311. The adapter 1311 converts the information inputted from the CPU 1306 to a format that can be interpreted by the broadcast station side system 101, and inputs this to the QPSK modulator 1301c. The QPSK modulator 1301c QPSK-modulates the information inputted from the adapter 1311, and sends this to the broadcast station side system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313.

The multiplexer 1313 is a device with a function for multiplexing video and audio inputted from the AV encoder 1312, onto the MPEG-2 transport stream.

An operation in which the broadcast recording and reproduction apparatus described above records a service contained in a broadcast signal into the secondary storage unit 1307, and an operation where the broadcast recording and reproduction apparatus sequentially reads out and reproduces the service from the secondary storage unit 1307, are hereafter described in detail.

First, the process in which the service contained in the broadcast signal is recorded into the secondary storage unit 1307 is described.

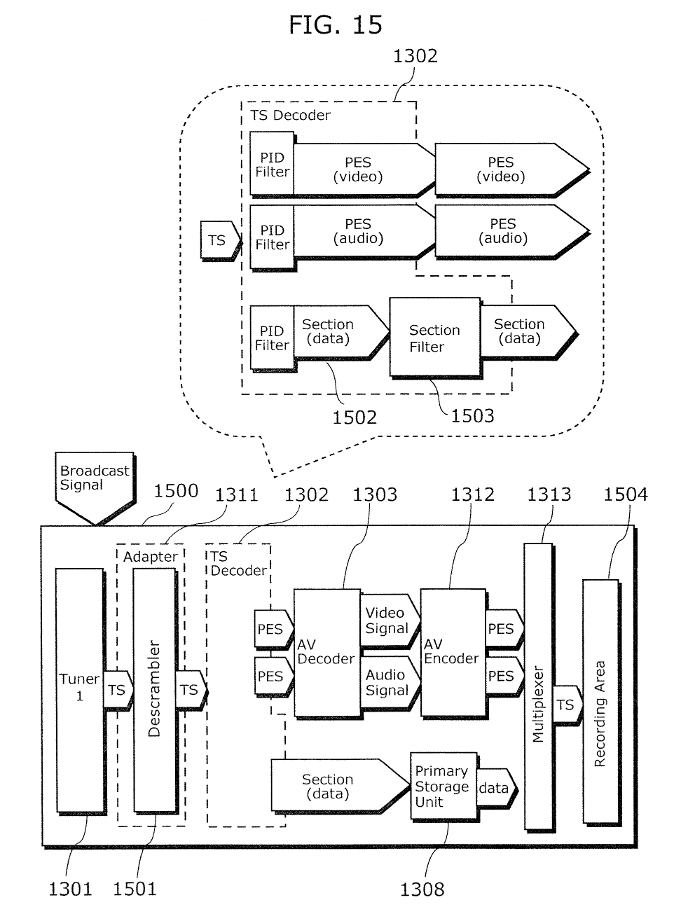

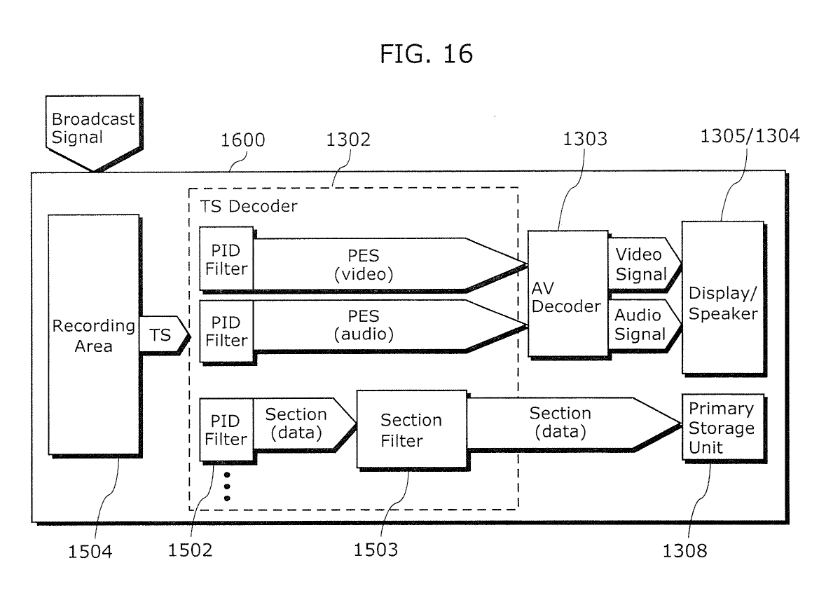

FIG. 15 shows a conceptual rendering which expresses the physical connection sequence, processing details, and input/output data format of each device during recording of the service. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504. Constituent elements in FIG. 15 that have the same numbers as in FIG. 13 have the same functions and thus descriptions are omitted.

First, the tuner 1301 performs tuning on the broadcast signal in accordance with a tuning information instructed by the CPU 1306. Here, the tuning information is information that can identify a frequency, a modulation format, and the like. The tuner 1301 demodulates the broadcast signal and inputs the MPEG-2 transport stream into the adapter 1311.

The descrambler 1501, which is included in the adapter 1311, descrambles the MPEG-2 transport stream based on conditional access information for each viewer. The descrambled MPEG-2 transport stream is inputted into the TS decoder.

Two types of devices that process the MPEG-2 transport stream are present within the TS decoder 1302, namely, the PID filter 1502 and the section filter 1503.

The PID filter 1502 extracts, from the inputted MPEG-2 transport stream, a TS packet that has a PID specified by the CPU 1306, and then extracts a PES packet and an MPEG-2 section present in that payload. For example, when the MPEG-2 transport stream in FIG. 6 is inputted in the case where the CPU 1306 has instructed PID filtering which extracts the TS packet with a PID=100, packets 601 and 603 are extracted, then linked, and thus a PES packet of a video 1 is reconfigured. Alternatively, when the MPEG-2 transport stream in FIG. 6 is inputted in the case where the CPU 1306 has instructed PID filtering which extracts the TS packet with a PID=200, packets 602 and 605 are extracted, then linked, and thus an MPEG-2 section of data 1 is reconfigured.

The section filter 1503 extracts the MPEG-2 section which conforms to a section filter condition specified by the CPU 1306 from among the inputted MPEG-2 sections, and DMA-transfers this MPEG-2 section to the primary storage unit 1308. For example, the CPU 1306 specifies PID filtering which extracts the TS packet with a PID=200, and section filtering which extracts a section with a table_id of 64, to the section filter 1503. As mentioned earlier, after the MPEG-2 section of the data 1 is reconfigured, the section filter 1503 extracts only the section with a table_id of 64 from among those MPEG-2 sections, and DMA-transfers this to the primary storage unit 1308.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet and converts the video, and inputs this into the AV encoder 1312. The AV decoder also decodes the audio PES packet and converts the audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder onto the MPEG-2 section inputted from the primary storage unit 1308, and thus generates an MPEG-2 transport stream. The generated MPEG-2 transport stream is recorded into the recording area 1504.

The recording area 1504 is made up of all or a part of the secondary storage unit 1307, or an other recording area, and records the MPEG-2 transport stream that makes up a service.

Next, a process is described in which the service is consecutively read out from the secondary storage unit 1307 and reproduced.

FIG. 16 shows a conceptual diagram which expresses the physical connection sequence, processing details, and input/output data format of each device during reproduction of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same numbers as in FIG. 13 have the same functions and thus description is omitted.

In the order described in FIG. 15, the MPEG-2 transport stream recorded in the recording area 1504 is inputted into the TS decoder 1302.

Next, a video PES and an audio PES that have a PID specified by the CPU 1306 are extracted by the PID filter 1502 within the TS decoder 1302. The extracted PES packet is inputted into the AV decoder 1303. Or, the MPEG-2 section that has a PID and a table_id specified by the CPU 1306 is extracted by the PID filter 1502 and the section filter 1503 within the TS decoder 1302. The extracted MPEG-2 section is DMA-transferred to the primary storage unit 1308.

The video PES and the audio PES inputted into the AV decoder 1303 are decoded, and outputted as an audio signal and a video signal. After that, the audio signal and the video signal are inputted into the display 1305 and the speaker 1304, thus reproducing the audio and the video.

The MPEG-2 section inputted into the primary storage unit 1308 is inputted into the CPU 1306 when appropriate.

Thus far, an example of a hardware configuration regarding the present invention has been described. Hereafter, a chief function of the present invention, which is control of recording of the service via a Java program, is described.

Recording of the service in the present invention refers to recording video, audio, a Java program, synchronization information of the Java program, and so on that are contained in the service, into a storage medium such as a hard disk, a Blu-ray Disc (BD), a Digital Versatile Disc (DVD), and a Secure Digital (SD) memory card. Reproduction of the service refers to reproduction and execution of the video, audio, and Java program recorded in the recording medium based on the synchronization information. A reproduction result of a recorded service is required to be almost equivalent to a result of directly reproducing the service upon receiving a broadcast signal.

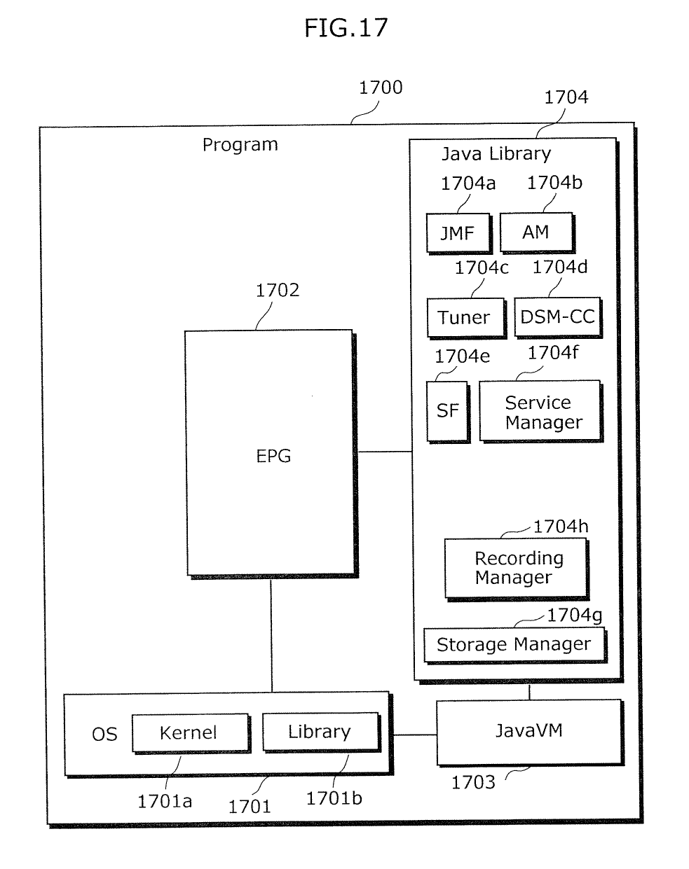

FIG. 17 is a configuration diagram of a program necessary for recording and reproduction of the service, and is software recorded into the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of: a kernel 1701a for executing other sub-programs such as the EPG 1702 and the Java VM 1703; and a library 1701b which the sub-programs use to control the constituent elements of the terminal apparatus 1300. The kernel 1701a is publicly-known technology and therefore detailed descriptions are omitted.

The library 1701b provides, for example, a tuning function for controlling the tuner. The library 1701b accepts, from another sub-program, tuning information that identifies the frequency, modulation format, and so on, and supplies this to the tuner 1301. The tuner 1301 can perform demodulation processing based on the provided tuning information, and pass the demodulated MPEG-2 transport stream to the TS decoder 1302. As a result, other sub-programs can control the tuner 1301 through the library 1701b.

Furthermore, the library 1701b provides channel information for uniquely identifying a channel.

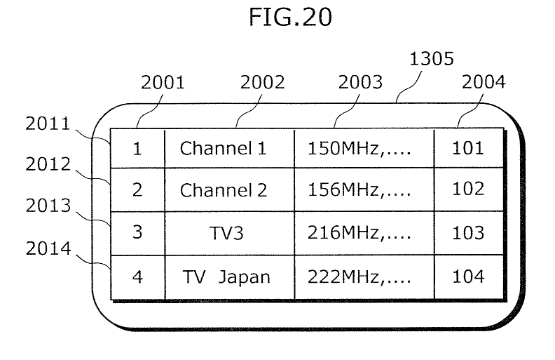

An example of the channel information is shown in FIG. 20. The channel information is sent using the OOB or the In-band frequency range, is converted into a chart format by the adapter 1311, and is stored in a temporary memory unit accessible by the library. A column 2001 is a channel identifier, and is equivalent to, for example, a source_ID as defined by SCTE65 Service Information Delivered Out-Of-Band For Digital Cable Television. A column 2002 is a channel name, and is equivalent to a source_name in the same SCTE65 standard. A column 2003 is tuning information, and is information identifying a frequency, a transfer rate, and a modulation format, that is given to the tuner 1301. A column 2004 is a program number for specifying the PMT. For example, a row 2011 is a group of service information including a channel identifier of “10”, a channel name of “channel 10”, a frequency of “150 MHz . . . ” in the tuning information, and a program number of “101”.

The Java VM 1703 is a Java virtual machine which sequentially analyzes and executes programs written in the Java™ language. Programs written in the Java language are compiled into an intermediate code, called bytecode, which is not dependent on hardware. The Java virtual machine is an interpreter which executes this bytecode. The Java VM 1703 executes the Java library 1704 that is written in the Java language. Details of the Java language are explained in publications such as “Java Language Specification” (ISBN 0-201-63451-1) and “Java Virtual Machine Specification” (ISBN 0-201-63451-X). In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by the Java program in order to control functions of the broadcast recording and reproduction apparatus. However, there are also situations where a sub-program written in a non-lava language, such as the library 1701b of the OS 1701, is used as necessary. The Java program can use a function provided by the Java library 1740 by calling a Java Application Programming Interface (API) held by the Java library 1704.

A tuner 1704c is a Java library for controlling the In-band receiving tuner 1301a in the broadcast recording and reproduction terminal. When the Java program passes tuning information to the tuner 1704c, the tuner 1704c uses that information to invoke a tuning function of the library 1701b, and as a result, it is possible to control the operation of the In-band receiving tuner 1301a of the broadcast recording and reproduction terminal. Here, the tuning information is information that can identify a frequency, a modulation format, and the like.

An SF 1704e is a Java library for controlling a function of the PID filter 1502 and the section filter 1503 of the broadcast recording and reproduction terminal. When the Java program passes filtering conditions such as a PID, table_id, and the like to the SF 1704e, the SF 1704e uses a function of the library 1701b to control the PID filter 1502 and the section filter 1503 based on those conditions, acquires an MPEG-2 section that satisfies the desired filtering conditions, and passes the MPEG-2 section to the Java program that set the filtering conditions.

A DSM-CC 1704d is a Java library for accessing a file system of a DSM-CC object carousel. The DSM-CC object carousel is included in the MPEG-2 section acquired by the SF 1704e. The DSM-CC is defined by the ISO/IEC 13818-6 standard, and is a mechanism for using the MPEG-2 section to send an arbitrary file. By using this, it is possible to send a file from a broadcast station to a terminal. Based on a file identifier specified by the Java program and so on, the DSM-CC 1704d uses the SF 1704e and acquires the MPEG-2 section and, based on the ISO/IEC 13818-6 standard, fetches a file and outputs this file to the primary storage unit 1308. A detailed method for implementing the DSM-CC is of no relation to the present invention, and therefore details are omitted.

An AM 1704b is an Application Program Manager that provides a function for managing the execution and termination of the Java programs contained in the service. The AM 1704b extracts a Java program multiplexed into a channel specified by a specified MPEG-2 transport stream, and causes the execution or termination of that extracted Java program in accordance with separately-multiplexed synchronization information. A Java class file of the Java program is multiplexed into the MPEG-2 transport stream in the aforementioned DSM-CC format. In addition, the synchronization information of the Java program is in a format called AIT, and is multiplexed into the MPEG-2 transport stream. AIT is an acronym of Application Information Table, as defined in section 10 of the DVB-MHP specification (ETSITS 101812 DVB-MHP specification V1.0.2), and is an MPEG-2 section with a table_id of “0x74”.

With the MPEG-2 transport stream and the channel identifier as an input, the AM 1704b monitors the AIT update condition and, when the AIT is updated, executes processes such as the start up and termination of a Java program based on the AIT. First, the AM 1704b searches channel information in the library 1701b, with the specified channel identifier as a key, and obtains the program number. Next, using the SF 1704e and the like, the PAT is acquired from the MPEG-2 transport stream. In addition, the PID of a PMT that corresponds to the obtained program number is obtained from information of the PMT. Once again, using the SF 1704e, the actual PMT is acquired. The acquired PMT is in a format as shown in FIG. 11, and has written the PID of an elementary stream having “data” as a stream identifier and “AIT” as supplemental information. Furthermore, when the PID and table_ID “0x74” of the now-obtained AIT are given as the filtering conditions to the SF 1704e, the substance of the AIT is obtained.

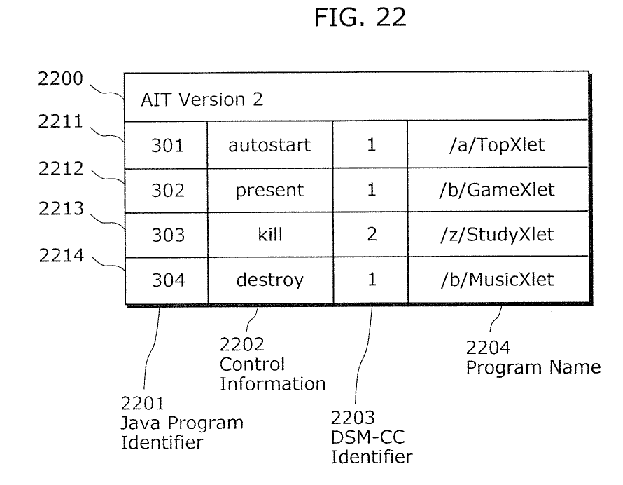

FIG. 22 is a chart that schematically shows an example of the AIT. An AIT version 2200 expresses the version of that AIT. The higher the version of the AIT, the newer the AIT is. AIT of the same AIT version are repeatedly received, but the AM 1704b does not analyze an AIT with the same AIT version as an AIT that has already been acquired, and only analyzes then performs a corresponding process an AIT that is newer than the already-analyzed AIT. A column 2201 is an identifier of the Java program. A column 2202 is control information of the Java program. In the control information, there is “autostart”, “present”, “kill”, and the like; “autostart” means that the terminal apparatus 1300 executes the Java program automatically in an instant, “present” means not performing automatic execution, and “kill” means stopping the Java program. A column 2203 is a DSM-CC identifier for extracting the PID that includes the Java program in the DS-MCC format. A column 2204 is a program name of the Java program.

Rows 2211, 2212, 2213, and 2214 are groups of the information of the Java program. The Java program defined by row 2211 is the group of the Java program identifier “301”, the control information “autostart”, the DSM-CC identifier “1”, and the program name “a/TopXlet”. The Java program defined in row 2212 is a group including a Java program identifier “302”, the control information “present”, a DSM-CC identifier “1”, and a program name “b/GameXlet”. Here, the three Java programs defined by rows 2211, 2212, and 2214 have the same DSM-CC identifier. This indicates that three Java programs are included in one file system encoded using one DSM-CC format. Here, only four types of information are prescribed for the Java program, but in reality, more types of information are defined. Details can be found in the DVB-MHP specifications.

The AM 1704b controls the execution status of a Java program by analyzing the details of the updated AIT. First, the AM 1704b finds a Java program with control information of “autostart” from within the AIT, and extracts the corresponding DSM-CC identifier and Java program name. Referring to FIG. 22, the AM 1704b extracts the Java program from row 2211 and acquires the DSM-CC identifier of “1” and the Java program name of “a/TopXlet”. Next, using the DSM-CC identifier acquired from the AIT, the PID of the TS packet which stores the Java program using a DSM-CC format is obtained from the PMT. Specifically, the PID of an elementary stream, within the PMT, having “data” as a stream identifier and a matching DSM-CC identifier as supplemental information is obtained. Here, assuming a DSM-CC identifier of “1” and the PMT in FIG. 11, the elementary stream from row 1114 matches and PID “5014” is extracted.

The AM 1704b specifies, to the SF 1704e, the PID of the TS packet transmitting an MPEG-2 section in which data is embedded using the DSM-CC format, as well as the filtering conditions. Here, PID “5014” is given. As a result, the AM 1704b uses the DSM-CC 1704d to reconstruct the file system according to the DSM-CC format, and stores this in the primary storage unit 1308. Fetching data such as the file system from the TS packet in the MPEG-2 transport stream and saving the data into a storage means such as the primary storage unit 1308 and the secondary storage unit 1307 is hereafter called downloading.

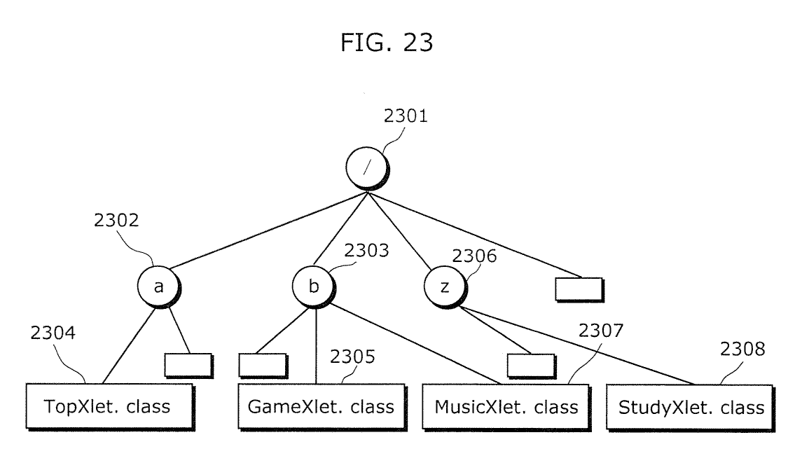

FIG. 23 is an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file “MusicXlet.class”, and 2308 is a file “StudyXlet.class”.

Next, the AM 1704b passes, to the Java VM 1703, the Java program to be executed from among the file systems downloaded to the primary storage unit 1308. Here, when the name of the Java program to be executed is “a/TopXlet”, the file “a/TopXlet.class”, in which “.class” is added to the end of the Java program name, is the file to be executed. “/” is a directory and file name delimiter, and referring to FIG. 23, the file 2304 is the Java program which should be executed. Next, when the AM 1704b passes the file 2304 to the Java VM 1703, such file is executed on the Java VM as a Java program. In the case where “kill” is specified in the control information, the Java program is caused to terminate.

Each time an AIT having a new AIT version comes, the AM 1704b analyzes such AIT and changes the execution status of the Java program.

A JMF 1704a handles control of reproduction of the video and audio contained in the service. Specifically, the video ES and the audio ES multiplexed into a specified channel of a specified MPEG-2 transport stream are inputted to the AV encoder and reproduced. In the case of reproducing a service directly from received broadcast signals, the reproduction of the MPEG-2 transport stream outputted from the adapter 1311 is specified. On the other hand, in the case of reproducing a service that is once recorded in the secondary storage unit 1307, the reproduction of the MPEG-2 transport stream outputted from the recording area 1504 in the secondary storage unit 1307 is specified.

First, the JMF 1704a searches the channel information in the library 1701b with the specified channel identifier as a key, and obtains the program number. Next, using the SF 1704e and the like, the PAT is acquired from the MPEG-2 transport stream. Then, the PID of a PMT that corresponds to the obtained program number is obtained from information of the PMT. Once again, using the SF 1704e, the actual PMT is acquired. The acquired PMT is in a format as shown in FIG. 11, and has written the PIDs of elementary streams that have “video” and “audio” as the stream identifiers. When the JMF 1704a sets these PIDs into the PID filter 1502 of the TS decoder 1302, the video ES and the audio ES multiplexed with the corresponding PIDs are reproduced via the AV decoder 1303, as shown in FIG. 15 or FIG. 16.

Here, particularly in the case where an MPEG-2 transport stream recorded in the secondary storage unit by the JMF 1704a is to be the input, the JMF 1704a is able to change the reproduction speed of the audio and the video by changing the read-out speed and the read-out position of the MPEG-2 transport stream from the recording area 1504 such as the secondary storage unit 1307. With this, trick play such as fast-forward and skip become possible. For example, by reading the MPEG-2 transport stream as a speed that is twice the normal speed, video and audio are also reproduced at twice the speed. Furthermore, by skipping the MPEG-2 transport stream read-out positions at specific intervals, the video and audio are skip-played. Using a function of the library 1701b, the JMF 1704a controls the secondary storage unit 1307 and changes the MPEG-2 transport stream read-out speed and read-out position. Since methods for smoothly performing such trick play at a high level are outside the scope of the present invention, description shall be omitted.

A storage manager 1704g manages storage, in other words, the recording area 1504 by dividing it into one or a plurality of units called a volume.

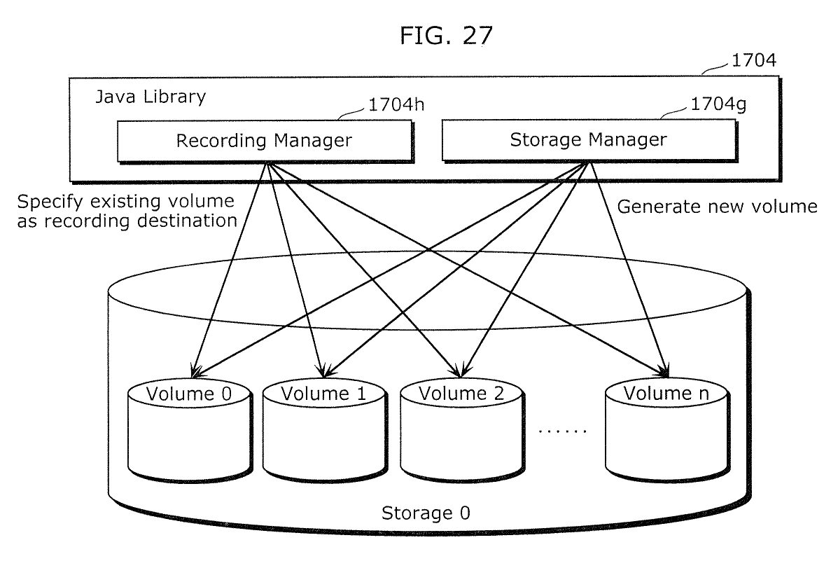

FIG. 27 is a schematic diagram representing the relationship between storage and volume. In one storage, one or plural volumes are generated by the storage manager 1704g. The recording manager 1704h specifies a certain volume as a volume to for recording the service.

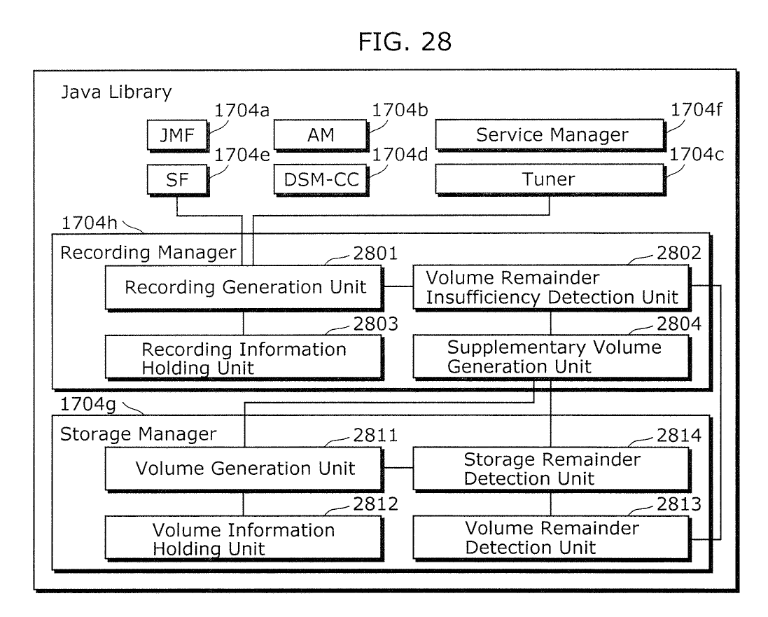

As shown in FIG. 28, the storage manager 1704g includes a volume generation unit 2811, a volume information holding unit 2812, a volume remainder detection unit 2813, and a storage remainder detection unit 2814.

The volume generation unit 2811 generates a volume in the recording area 1504, based on a volume name and volume capacity specified by a Java program or a supplementary volume generation unit 2804. For example, in the case where a volume name of “MEDIA” and a volume capacity of “10240” are specified, a 10240-kilobyte volume “MEDIA” is generated in the recording area 1504. Volume generation fails when the volume generation unit 2811 obtains, from the storage remainder detection unit 2814, the remaining capacity in the storage, in other words, the recording area 1504, and there is insufficient available capacity; or when the volume generation unit 2811 obtains, from the volume information holding unit 2812, volume information already existing in the recording area 1504, and a volume having the same name already exists. When volume generation is successful, information such as a volume identifier for identifying the volume, the volume name, the volume capacity, and so on, are notified to the volume information holding unit 2812, as volume information, and held therein, as well as recorded in the recording area 1504.

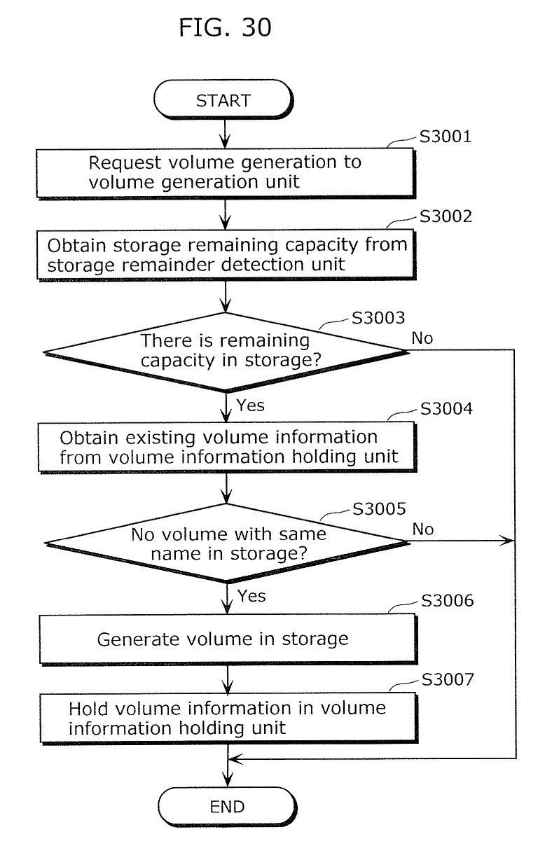

The process flow up to the generation of a volume specified by a Java program or the supplementary volume generation unit 2804 is shown in FIG. 30.

A volume name and a volume capacity is specified by the Java program or the supplementary volume generation unit 2804, and volume generation is requested to the volume generation unit 2811 (S3001). The volume generation unit 2811 obtains the remaining capacity in the storage from the storage remainder detection unit 2814 (S3002), and judges whether there is sufficient remaining capacity in the storage for the volume generation (S3003). In the case where the remaining capacity is not sufficient, the volume generation fails. In the case where the remaining capacity is sufficient, the volume generation unit 2811 obtains the volume information already existing in the storage from the volume information holding unit 2812 (S3004), and judges whether there is a volume with the same name exists in the storage (S3005). In the case where a volume with the same name already exists in the storage, the volume generation fails. In the case where a volume with the same name does not exist in the storage, the volume is generated (S3006) and a volume identifier for identifying the volume is assigned. Information such as the volume identifier, the volume name, the volume capacity, and so on, are notified to the volume information holding unit 2812, as volume information, and held therein (S3007).

The volume information holding unit 2812 holds, as volume information, information such as the volume identifier for identifying the volume notified by the volume generation unit 2811 during volume generation, the volume name, and the volume capacity. The volume information held in the volume information holding unit 2812 is obtained by the Java program and, when recording a service, a particular volume identifier is specified as the volume for storing the service.

Based on an inquiry from the Java program or a volume remainder sensing unit 2802, the volume remainder detection unit 2813 returns the capacity of a volume in which a content is not recorded at that point in time.

Based on an inquiry from the Java program, the volume generation unit 2811, or the supplementary volume generation unit 2804, the storage remainder detection unit 2814 returns the capacity of the storage, in other words, the recording area 1504, to which a volume is not assigned at that point in time.

In the present embodiment, the case of having one storage, in other words, the recording area 1504, is given but there can also be a plurality. In such case, a storage identifier for identifying the storage is, in addition, also specified to the volume generation unit 2811, the volume information holding unit 2812, the volume remainder detection unit 2813, and the storage remainder detection unit 2814.

The recording manager 1704h records the service currently being broadcast into a specified volume in the recording area 1504, at a specified bit rate, for the specified time period. As shown in FIG. 28, the recording manager 1704h includes a recording generation unit 2801, a volume remainder insufficiency sensing unit 2802, a recording information holding unit 2803, and the supplementary volume generation unit 2804.

Based on a channel identifier, a start time, an end time, a bit rate, and a volume identifier specified by the Java program, the recording generation unit 2801 records the service identified by the channel identifier into the specified volume in the recording area 1504, at the specified bit rate, only between the specified start time and end time. Furthermore, the specified channel identifier, the start time, the end time, the bit rate, and the volume identifier are notified, as recording information, to the recording information holding unit 2803 and held therein, as well as being recorded in the recording area 1504.

In addition, based on the recording identifier, the start time, the end time, the bit rate, and the volume identifier specified by the volume remainder insufficiency sensing unit 2802, the recording generation unit 2801 records, into the specified volume in the recording area 1504, a service which is identical to the currently-recording service identified by the recording identifier, at the specified bit rate, only between the specified start time and end time. In the same manner as the recording of the service identified by the channel identifier specified by the Java program, the channel identifier for identifying the service derived from the specified recording identifier, the start time, the end time, the bit rate, the volume identifier, and so on, are notified to the recording information holding unit 2803, as recording information, so as to be recorded therein, as well as being recording into the recording area 1504.

First, the process flow for the recording of the service identified by the channel identifier specified by the Java program shall be described hereafter.

When a channel identifier, start time, end time, bit rate, and volume identifier are specified by the Java program, the recording generation unit 2801 assigns a recording identifier for identifying such information as recording information, and remains on stand-by until the start time. Subsequently, when the start time is reached, the recording generation unit 2801 first forwards the recording identifier, the end time, and the volume identifier, from among the recording information, to the volume remainder insufficiency sensing unit 2802 so as to have the remaining capacity for recording the service monitored.

Next, with the channel identifier as a key, the recorded generation unit 2801 obtains tuning information that corresponds to the channel identifier from channel information held by the library 1701b. After that, when the tuner 1704c is supplied with the tuning information, the Tuner 1704c commences tuning. Here, the tuning information is information that can identify a frequency, a modulation format, and the like. Upon doing so, as shown in FIG. 15, the MPEG-2 transport stream is inputted into the TS decoder via the adapter 1311.

Furthermore, using the SF 1704e, the recording generation unit 2801 acquires the PAT from the MPEG-2 transport stream obtained through the tuning. In addition, the recording generation unit 2801 searches the library 1701b for a program number corresponding to the specified channel identifier, and searches the PAT for a PID of the PMT corresponding to the acquired program number. Subsequently, using the SF 1704e, the actual PMT is obtained, and all PIDs of the ES making up the specified channel. The recording generation unit 2801 sets the obtained PIDs into the PID filter of the TS decoder. In addition, the output destinations of the respective hardware constituent elements are set via the library 1701b so as to record the service included in the broadcast signal into the specified volume in the recording area 1504, at the specified bit rate. Then, in accordance with the flow described in FIG. 15, all ESs that make up a desired channel are recorded into the specified volume in recording area 1504, at the specified bit rate.

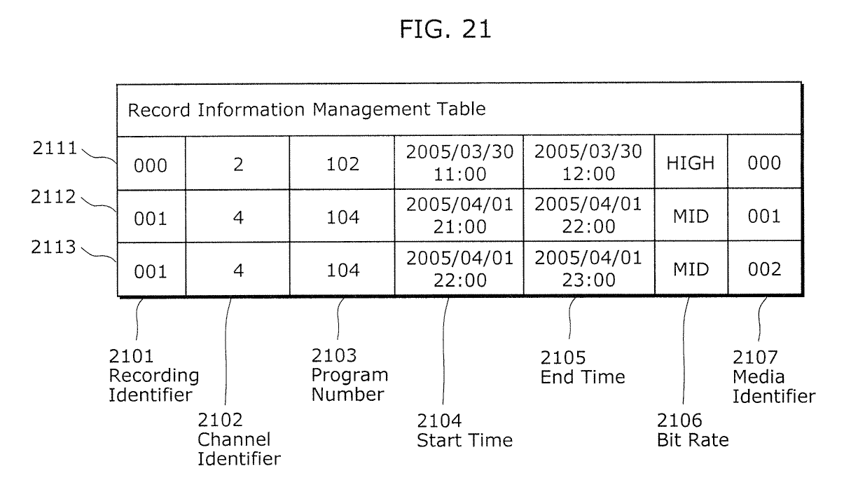

After that, when the specified end time is reached, the recording generation unit 2801 stops the tuning operation of the Tuner 1704c, and causes the writing of the MPEG-2 transport stream to the recording area 1504 to end. In addition, a recording information management table as shown in FIG. 21 is created as management information of the MPEG-2 transport stream recorded earlier.

FIG. 21 is an example of the recording information management table for managing the recording information held in the recording information holding unit 2803 or recorded into the recording area 1504 of the secondary storage unit 1307 and the like. The record information is recorded in a tabular format. A column 2101 is a recording identifier. A column 2102 is a channel identifier. A column 2103 is a program number. A column 2104 is a recording start time of the service, a column 2105 is a recording start time of the service. A column 2106 a bit rate for the recording of the service. A column 2107 is a media identifier that identifies the MPEG-2 transport stream that is recorded as the service.

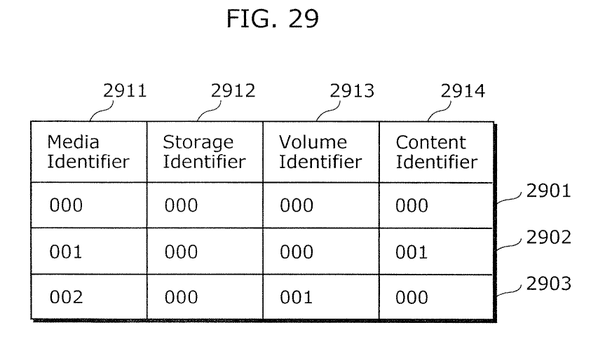

With the media identifier as a key and, in addition, by referring to the media information management table in FIG. 29, the identifier of the storage in which the content corresponding to the media identifier is recorded, identifier of the volume, and the identifier of the content is derived. Each of rows 2111 to 2113 is a group of each record identifier, channel identifier, program number, start time, end time, and media identifier. For example, row 2111 shows a record identifier of “000”, a channel identifier of “2”, a program number of “102”, a start time of “2005/03/30 11:00”, an end time of “2005/03/30 12:00”, a bit rate of “HIGH”, and a media identifier of “000”.

Next, the process flow of the recording of the service identified by the recording identifier specified by the volume remainder insufficiency sensing unit 2802 shall be discussed hereafter.

When the recording identifier, the start time, the end time, the bit rate, and the volume identifier are specified by the volume remainder insufficiency sensing unit 2802, the recording generation unit 2801 uses the specified recording identifier as a key and derives the corresponding recording information. Then, according to such recording information, the service currently being recorded is recorded into the specified volume in the recording area 1504, at the specified bit rate, only between the specified start time and end time.

However, unlike the recording of the service identified by the channel identifier specified by the Java program, the recording generation unit 2801 does not forward, from among the recording information, the recording identifier, the end time, the bit rate, and the volume identifier to the volume remainder insufficiency sensing unit 2802 even when the start time is reached, in other words, the recording generation unit 2801 does not cause the monitoring of the remaining capacity of the volume for recording the service.

Since the succeeding process flow is the same as in the recording of the service identified by the channel identifier specified by the Java program, description shall be omitted here.

In the case where the channel identifier, the start time, the end time, the bit rate, and the volume identifier are specified by the Java program and recording of a service is requested, or in the case where the recording identifier, the start time, the end time, the bit rate, and the volume identifier are specified by the volume remainder insufficiency sensing unit 2802, the recording information holding unit 2803 holds, as recording information, the recording identifier, the channel identifier, the program number, the start time, the end time, the bit rate, the media identifier, and the like, notified by the recording generation unit 2801. The recording information held in the recording information holding unit 2803 is obtained by the Java program and, at the time of service reproduction, a recording identifier is specified as a service to be reproduced.

Upon the recording start time of a certain service, the recording identifier, the end time, the bit rate, and the volume identifier are forwarded by the recording generation unit 2801 from among the recording information, and the volume remainder insufficiency sensing unit 2802 monitors the remaining capacity of the volume for recording the service. The volume identifier is forwarded to the volume remainder detection unit 2813 of the storage manager 1704g at fixed cycles, and the remaining capacity of the volume identified by the volume identifier is obtained. Furthermore, in the case where insufficient remaining capacity in the volume for recording the service is sensed, the volume name and volume capacity are forwarded to the supplementary volume generation unit 2804, and the generation of a supplementary volume is requested. Here, it is guaranteed that the volume name does not overlap with a volume name already existing in the storage. For example, “SUB_{—}000” and the like, in which “SUB” is a reserved word and “000” being the volume identifier for which remaining capacity insufficiency is sensed.

Furthermore, the volume capacity is the value calculated from the bit rate, and the remaining time up to the end time forwarded by the recording generation unit 2801. In addition, in the case where the generation of supplementary volume is successful, together with returning a supplementary volume identifier generated by the supplementary volume generation unit 2804, the recording identifier forwarded by the recording generation unit 2801, a recording start time, a recording end time, a bit rate, and the generated supplementary volume identifier are forwarded to the recording generation unit 2801, and generation of a supplementary recording is requested. Here, the recording start time is the time at which the remaining capacity of the currently recorded volume runs out. Furthermore, the recording end time, or the bit rate is set so as to allow the recording in the generated supplementary volume. As such, there is a possibility that these are different from the recording end time or bit rate forwarded by the recording generation unit 2801.

Based on the volume name and a supplementary volume capacity forwarded by the volume remainder insufficiency sensing unit 2802, the supplementary volume generation unit 2804 generates a supplementary volume and, when generation of the supplementary volume is successful, returns a generated supplementary volume identifier to the volume remainder insufficiency sensing unit 2802. When the supplementary volume name and the supplementary volume capacity are forwarded by the volume remainder insufficiency sensing unit 2802, the supplementary volume generation unit 2804 obtains the capacity of the storage to which a volume is not assigned, from the storage remainder detection unit 2814 of the storage manager 1704g. In the case where the remaining capacity of the storage obtained from the storage remainder detection unit 2814 is equal to or greater than the supplementary volume capacity forwarded by the volume remainder insufficiency sensing unit 2802, the supplementary volume generation unit 2804 specifies the supplementary volume capacity and supplementary volume name forwarded by the volume remainder insufficiency sensing unit 2802 to the volume generation unit 2811, and requests for the generation of a volume.

However, in the case where the remaining capacity of the storage obtained from the storage remainder detection unit 2814 is below the supplementary volume capacity forwarded by the volume remainder insufficiency sensing unit 2802, the supplementary volume generation unit 2804 specifies the remaining capacity of the storage, and the supplementary volume name obtained from the volume remainder insufficiency sensing unit 2814 to the volume generation unit 2811, and requests for the generation of a volume. When the volume generation is successful, a volume identifier generated from the volume generation unit 2811 is returned. In addition, the supplementary volume generation unit 2804 returns that volume identifier to the volume remainder insufficiency sensing unit 2802, as a supplementary volume identifier.

A service manager 1704f manages reproduction of the service within the MPEG-2 transport stream that has been recorded into the recording area 1504 such as the secondary storage unit 1307, or the service within the MPEG-2 transport stream inputted from the adapter 1311.

Hereafter, the process in the case of managing reproduction of the service contained within the MPEG-2 transport stream, which is recorded in a volume in the recording area 1504 is described. This is equivalent to reproduction of an already-recorded service. In this case, the service manager 1704f has the recording identifier as an input. The service already recorded in the volume in the recording area 1504 and specified by that recording identifier is to be reproduced.

First, referring to the recording information management table generated by the recording manager 1704h, the service manager 1704f obtains the channel identifier and the media identifier for reproduction, through the specified record identifier.

Referring to the recording information management table, in the case where there is a plurality of the same recording identifiers, the channel identifiers and media identifiers for reproduction are obtained according to an order of the earliest recording start time. Then, the contents identified by these media identifiers are consecutively reproduced. For example, in the recording information management table in FIG. 21, the row 2112 and the row 2113 have the same recording identifier “001”. In the case where “001” is specified to the service manager 1704f as the recording identification for reproduction, the recording start time “2005/04/01 21:00” in the row 2112 and the recording start time “2005/04/01 22:00” in the row 2113 are compared, and the channel identifier and media identifier are obtained from the earlier row 2112 and reproduced. When the end point of the reproduction of the row 2112 is reached, the channel identifier and media identifier are obtained from the row 2113 and reproduced from the start point. Furthermore, by rewinding, when the reproduction of the row 2113 reaches the start point, the channel identifier and media identifier are obtained from the row 2112 and reproduced from the end point.

Then, through the library 1701b, the TS decoder 1302 is instructed to output, to the recording area 1504, the MPEG-2 transport stream specified by the obtained media identifier. In addition, through the library 1701b, the output destination of each hardware constituent element is set to flow through the path shown in FIG. 16. After that, the volume in the recording area 1504 is provided to the JMF 1704a as the location of the MPEG-2 transport stream, and the channel identifier to be reproduced is provided. Then, through the operation described above, the JMF 1704a starts reproduction of the audio and video multiplexed into the MPEG-2 transport stream outputted from the recording area 1504. Furthermore, the volume in the recording area 1504 is also provided to the AM 1704b as the location of the MPEG-2 transport stream, and the channel identifier to be reproduced is provided. Then, in accordance with the AIT multiplexed into the MPEG-2 transport stream outputted from the volume in the recording area 1504, the AM 1704b commences execution and termination of the Java program multiplexed into the MPEG-2 transport stream outputted from the volume in the recording area 1504. After that, reproduction of the service is continued until the end of the MPEG-2 transport stream outputted from the volume in the recording area 1504.

On the other hand, the case of managing reproduction of the service within the MPEG-2 transport stream inputted from the adapter 1311 is described hereafter. This is corresponds to reproducing the service directly from the broadcast signal. In this case, the service manager 1704f has the channel identifier of the service to be reproduced as an input.

Through the library 1701b, the service manager 1704f instructs the TS decoder 1302 to output the MPEG-2 transport stream outputted from adapter 1311 in FIG. 15. In addition, through the library 1701b, the service manager 1704f sets the output destination of each hardware constituent element to flow through the path shown in FIG. 16. Next, with the channel identifier as a key, the service manager 1704f obtains tuning information that corresponds to the channel identifier, from channel information held by the library 1701b. After that, when the tuning information is provided to the Tuner 1704c, the Tuner 1704c commences tuning. Here, the tuning information is information that can identify a frequency, a modulation format, and the like.

After that, the adapter 1311 is provided to the JMF 1704a as the location of the MPEG-2 transport stream, and the channel identifier to be reproduced is provided. Then, through the process described above, the JMF 1704a starts reproduction of the audio and video multiplexed within the MPEG-2 transport stream outputted from the adapter 1311. Furthermore, the adapter 1311 is provided to the AM 1704b as the location of the MPEG-2 transport stream, and the channel identifier to be reproduced is provided. Then, in accordance with the AIT multiplexed into the MPEG-2 transport stream outputted from the adapter 1311, the AM 1704b commences execution and termination of the Java program multiplexed into the MPEG-2 transport stream outputted from the secondary storage unit 1307. After that, reproduction of the service is continued until the end of the MPEG-2 transport stream outputted from the secondary storage unit 1307.

The EPG 1702 is an Electronic Program Guide, and is a function which lets a user choose a TV show to be recorded and reproduced. Normal reproduction through receiving a broadcast signal deviates from the scope of the present invention and thus descriptions are omitted.

In the case of recording a TV show, the EPG 1702 displays a list of broadcasted TV shows, and lets the user choose a desired TV show.

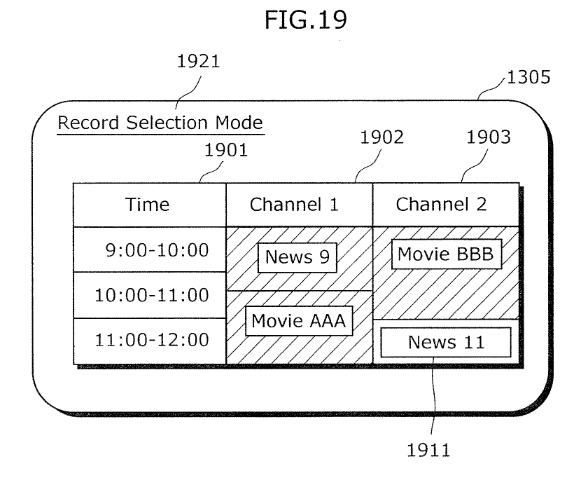

FIG. 19 is an example of a screen display for letting the user select a TV show to be recorded. A time 1901 and channels 1902 and 1903 are displayed in a grid, and it is possible to check the TV shows of each recordable channel at each time. The user can move a focus 1911 within the screen by using top, bottom, right, and left cursor buttons 1401 to 1404, which are included in the input unit 1310 of the terminal apparatus 1300. Furthermore, when an OK button 1405 is pushed, the TV show which the focus currently hits is selected for recording. The EPG 1702 acquires the channel identifier of the TV show from the library, and when the TV show to be recorded is selected by the user, notifies the channel identifier, start time, and end time of the TV show to the recording manager 1704h. Based on that information, the recording manager 1704h records the TV show into the secondary storage unit 1307. Although it also possible to specify, in addition, the bit rate and volume for recording into the secondary storage unit 1307, such is omitted here. In the case where the bit rate and volume for recording into the secondary storage unit 1307 is not specified, recording is carried out at a bit rate of a prescribed value, and into a prescribed volume.

On the other hand, in the case of reproducing an already-recorded TV show, the EPG 1702 displays a list of already-recorded TV shows, and lets the user choose a desired TV show.

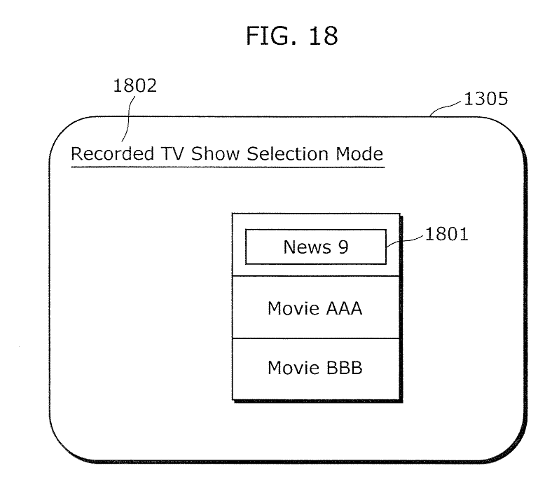

FIG. 18 is an example of a screen display for causing selection of an already-recorded TV show. All TV shows stored in the secondary storage unit 1307 at that point in time are listed. The user can move a focus 1801 within the screen by using the top and bottom cursor buttons 1401 and 1402, which are included in the input unit 1310 of the terminal apparatus 1300. Furthermore, when the OK button 1405 is pushed, the TV show which the focus currently hits is selected to be reproduced. The EPG 1702 acquires the recording identifier of the TV show from recording manager 1704h, and when the TV show to be reproduced is selected by the user, notifies the service manager 1704f of the recording identifier of that TV show. Based on that information, the service manager 1704f reads out and reproduces the TV show from the secondary storage unit 1307.

The characteristic operation in the present embodiment in the configuration described above shall be described using the following flowchart.

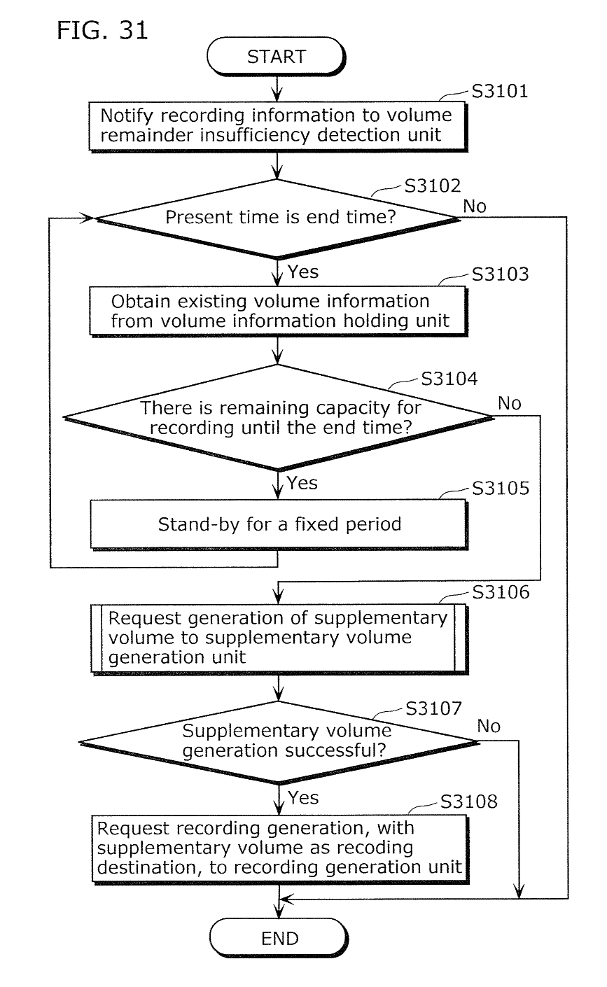

FIG. 31 is a flowchart showing the process flow from when the recording of a service starts, and an insufficiency in the remaining capacity of the volume for recording the service is sensed, to when a supplementary recording is generated.

When the recording start time of the service is reached, the recording generation unit 2801 forwards, to the volume remainder insufficiency sensing unit 2802, the recording identifier, the end time, the bit rate, and the volume identifier, from among the recording information (S3101). The volume remainder insufficiency sensing unit 2802 determines whether the present time exceeds the recording end time of the service (S3102) and the process terminates when the recording end time of the service is exceeded. When the recording end time of the service is not exceeded, the volume identifier is forwarded to the volume remainder detection unit 2813 of the storage manager 1704g, and the remaining capacity of the volume identified by that volume identifier is obtained (S3103). The obtained remaining capacity of the volume and the estimated required volume capacity are compared (S3104), and when the remaining capacity of the volume is equal to or greater than the estimated required volume capacity, the recording generation manager goes on stand-by until a fixed period passes (3105).

Then, after the fixed period passes, it is again determined whether the present time exceeds the recording end time of the service (S3102) and, when not exceeded, the remaining capacity of the volume is obtained from the volume remainder detection unit 2813 of the storage manager 1704g (S3103), and it is determined whether the remaining capacity of the volume is equal to or greater than the required volume capacity (S3104). When the remaining capacity of the volume is below the required volume capacity, the volume name and the volume capacity are forwarded to the supplementary volume generation unit 2804, and generation of a supplementary volume is requested (S3106). Here, it is guaranteed that the volume name does not overlap with a volume name already existing in the storage. For example, “SUB_{—}000” and the like, in which “SUB” is a reserved word and “000” being the volume identifier for which remaining capacity insufficiency is sensed. Furthermore, the volume capacity is the value calculated from the bit rate, and the remaining time up to the end time forwarded by the recording generation unit 2801. Next, the generation of the supplementary volume is determined (S3107).

In the case where the generation of the supplementary volume fails, the process ends. In the case where the generation of supplementary volume is successful, together with returning a supplementary volume identifier generated by the supplementary volume generation unit 2804, the recording identifier forwarded by the recording generation unit 2801, a recording start time, a recording end time, a bit rate, and the generated supplementary volume identifier are forwarded to the recording generation unit 2801, and generation of a supplementary recording is requested (S3108). Here, the recording start time is the time at which the remaining capacity in the volume runs out. Furthermore, the recording end time, or the bit rate is set so as to allow the recording in the generated supplementary volume. As such, there is a possibility that these are different from the recording end time or bit rate forwarded by the recording generation unit 2801.

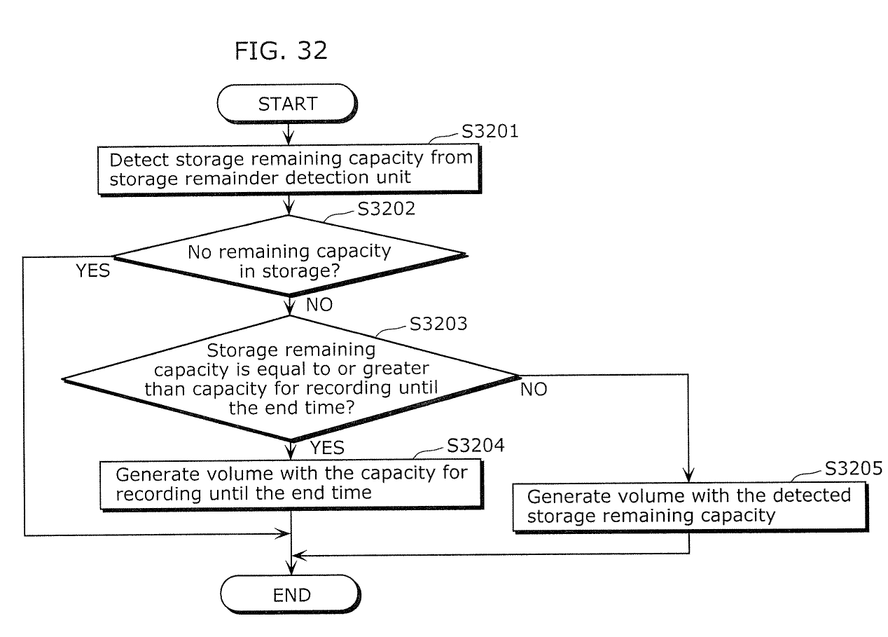

FIG. 32 is a flowchart showing the process flow from when the volume remainder insufficiency sensing unit 2802 requests the generation of a supplementary volume to the supplementary volume generation unit 2804, to when the supplementary volume generation of the supplementary volume generation unit 2804 succeeds or fails.

When the supplementary volume name and the supplementary volume capacity are forwarded by the volume remainder insufficiency sensing unit 2802, the supplementary volume generation unit 2804 obtains, from the storage remainder detection unit 2814 of the storage manager 1704g, the capacity of the storage to which a volume is not assigned (S3201). First, it is determined whether there is a remaining capacity in the storage capacity obtained from the storage remainder detection unit 2814 (S3202). In the case where there is no remaining capacity in the obtained storage capacity, the supplementary volume generation fails, and the process ends. In the case where there is a remaining capacity in the obtained storage capacity, it is further determined whether the storage remaining capacity obtained from the storage remainder detection unit 2814 is equal to or greater than the supplementary volume capacity forwarded by the volume remainder insufficiency sensing unit 2802 (S3203). In the case where the obtained remaining capacity of the storage is equal to or greater than the required supplementary volume capacity, the supplementary volume generation unit 2804 specifies the supplementary volume capacity and the supplementary volume name forwarded by the volume remainder insufficiency sensing unit 2802, and requests the generation of a volume to the volume generation unit 2811 (S3204).

However, in the case where the obtained remaining capacity of the storage is below the required supplementary volume capacity, the supplementary volume generation unit 2804 specifies the remaining capacity of the storage and the supplementary volume name obtained from the storage remainder detection unit 2814, and requests the generation of a volume to the volume generation unit 2811 (S3205). When the volume generation is successful, a volume identifier generated by the volume generation unit 2811 is returned. In addition, the supplementary volume generation unit 2804 returns such volume identifier to the volume remainder insufficiency sensing unit 2802 as a supplementary volume identifier.

In such manner, when, at the time of service recording, an insufficiency in the remaining capacity in the volume for recording the service is sensed, a volume is generated in the surplus portion of the storage, and the portion of the service that cannot be recorded is recorded in the supplementary volume. Therefore, it becomes possible to utilize the surplus portion of the storage and complete the recording of the service.

### Second Embodiment

Hereafter, an apparatus and a method according to the second embodiment of the present invention are described with reference to the drawings.

Since the hardware configuration, and the like, used in the second embodiment is the same as in the first embodiment, FIG. 1 to FIG. 16 shall be invoked. Since constituent elements in the diagrams have the same functions as the constituent elements having the same names and numerical references in the first embodiment, repeated description shall be omitted.

The software configuration in the second embodiment is the same as that shown in FIG. 17. Since the constituent elements aside from the storage manager 1704g and the recording manager 1704h have the same functions as the constituent elements having the same names and numerical references in the software configuration in the first embodiment, repeated description shall be omitted. Furthermore, since the respective data formats used in the second embodiment are the same as those shown in FIG. 20 to FIG. 22, and FIG. 29, repeated description shall be omitted.

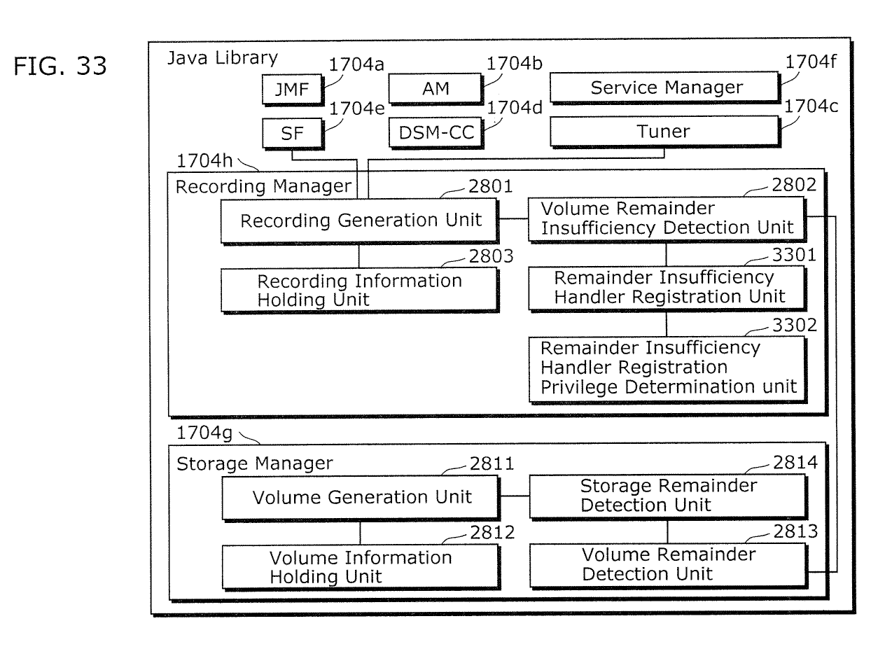

FIG. 33 is a diagram showing a detailed configuration of the storage manager 1704g and the recording manager 1704h of the Java library 1704.

A storage manager 1704g manages storage, in other words, the recording area 1504 by dividing it into one or a plurality of units called a volume. The storage manager 1704g includes a volume generation unit 2811, a volume information holding unit 2812, a volume remainder detection unit 2813, and a storage remainder detection unit 2814. Since the volume information holding unit 2812 and the volume remainder detection unit 2813 have the same functions as in the first embodiment, repeated description shall be omitted.

The volume generation unit 2811 generates a volume in the recording area 1504, based on the volume name and volume capacity specified by the Java program. Since the process flow for generating the volume is the same as in the first embodiment, repeated description shall be omitted.

In accordance with an inquiry from the Java program or the volume generation unit 2811, the storage remainder detection unit 2814 returns the capacity of the storage, in other words, the recording area 1504, to which a volume is not assigned at that point in time.

The recording manager 1704h records the service currently being broadcast into a specified volume in the recording area 1504, at a specified bit rate, for the specified time period. The recording manager 1704h includes a recording generation unit 2801, a volume remainder insufficiency sensing unit 2802, a recording information holding unit 2803, a remainder insufficiency handler registration unit 3301 and a remainder insufficiency handler registration privilege determination unit 3302.

The remainder insufficiency handler registration unit 3301 holds a remainder insufficiency handler that is registered in advance by a privileged Java program, for responding to an insufficiency in a volume's remaining capacity, and which is invoked when insufficient remaining capacity in the volume for the current recording of the service is sensed by the volume remainder insufficiency detection unit 2802, by the forwarding, thereto, of the recording identifier identifying the current recording of the service.

In the case where a certain Java program attempts to register a remainder insufficiency handler in the remainder insufficiency handler registration unit 3301, the remainder insufficiency handler registration privilege determination unit 3302 has a Java program identifier identifying such Java program forwarded from the remainder insufficiency handler registration unit 3301, and determines whether the Java program has the privilege required for registering the remainder insufficiency handler. In the case where the Java program is a Java program having such privilege, the remainder insufficiency handler is held in the remainder insufficiency handler registration unit 3301. For example, in order for a certain Java program to register a remainder insufficiency handler “IHandler” in the remainder insufficiency handler registration unit 3301, a “setLackHandler (IHandler)” is called using a Java method “setLackHandler” for registering a remainder insufficiency handler. Here, the recording identifier “recID” identifying the current recording of the service, and the like, are given as the argument of the remainder insufficiency handler “IHandler”.

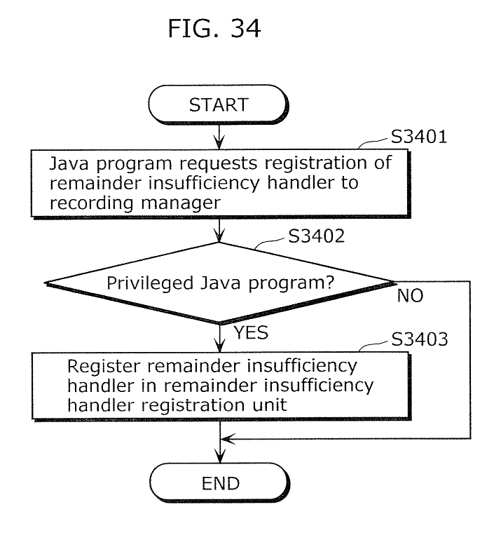

FIG. 34 is a flowchart in the case where a certain Java program registers a remainder insufficiency handler in the remainder insufficiency handler registration unit 3301 of the recording manager 1704h.

The Java program attempting to register a remainder insufficiency handler first requests the recording manager 1704h to register the remainder insufficiency handler (S3401). Upon receiving the remainder insufficiency handler registration request, the recording manager 1704h judges, using the remainder insufficiency handler registration privilege determination unit 3302, whether that Java program has the privilege required for registering the remainder insufficiency handler (S3402). In the case where it is judged that the Java program has the privilege required for registering the remainder insufficiency handler, the remainder insufficiency handler requested by the Java program is registered in the remainder insufficiency handler registration unit 3301 (S3403).

Based on a channel identifier, a start time, an end time, a bit rate, and a volume identifier specified by the Java program, the recording generation unit 2801 records the service identified by the channel identifier into the specified volume in the recording area 1504, at the specified bit rate, only between the specified start time and end time. Furthermore, the specified channel identifier, the start time, the end time, the bit rate, and the volume identifier are notified, as recording information, to the recording information holding unit 2803 and held therein, as well as being recorded in the recording area 1504.

Furthermore, based on the recording identifier specified by the remainder insufficiency handler provided for the Java program, the recording generation unit 2801 terminates the current recording of the service identified by the recording identifier.

First, since the process flow for the recording of the service identified by the channel identifier specified by the Java program is the same as in the first embodiment, repeated description shall be omitted.

Next, the process flow for the termination of the current recording of the service identified by the recording identifier specified by the remainder insufficiency handler provided for the Java program shall be described hereafter.

When a recording identifier is specified by the remainder insufficiency handler provided for the Java program and the termination of the current recording of the service identified by such recording identifier is requested, the recording generation unit 2801 uses the specified recording identifier as a key and derives the corresponding recording information from the held recording information. Subsequently, through such recording information, the current recording of the service is terminated. Specifically, the recording generation unit 2801 stops the tuning operation of the Tuner 1704c, and causes the writing of the MPEG-2 transport stream to the specified volume in the recording area 1504 to end. In addition, a recording information management table as shown in FIG. 21 is generated as management information of the MPEG-2 transport stream recorded earlier.

Since the recording information holding unit 2803 has the same functions as in the first embodiment, repeated description shall be omitted.

Upon the recording start time of a certain service, the recording identifier, the end time, the bit rate, and the volume identifier are forwarded by the recording generation unit 2801 from among the recording information, and the volume remainder insufficiency sensing unit 2802 monitors the remaining capacity of the volume for recording the service. The volume identifier is forwarded to the volume remainder detection unit 2813 of the storage manager 1704g at fixed cycles, and the remaining capacity of the volume identified by the volume identifier is obtained. Furthermore, in the case where an insufficiency in the remaining capacity of the volume for recording the service is sensed, the recording identifier identifying the current recording of the service for which volume remaining capacity insufficiency has been sensed is forwarded to the remainder insufficiency handler registration unit 3301, and calling of the remainder insufficiency handler registered in the remainder insufficiency handler registration unit 3301 is requested.

The remainder insufficiency handler, having the recording identifier identifying the current recording of the service for which the volume remaining capacity insufficiency has been sensed forwarded from the remainder insufficiency handler registration unit 3301, is executed. The remainder insufficiency handler specifies such recording identifier to the recording generation unit 2801 and requests the termination of the recording of the service derived from the recording identifier.

The characteristic operation in the present embodiment in the configuration described above shall be described using the following flowchart.

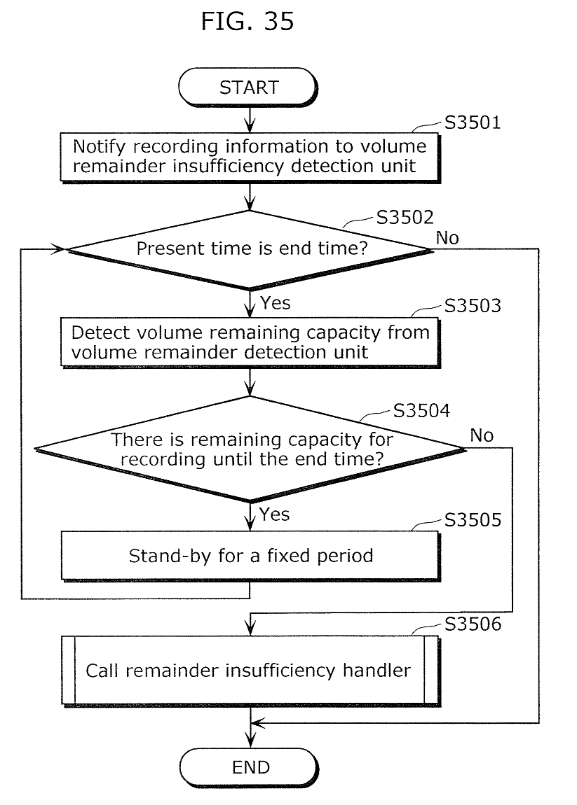

FIG. 35 is a flowchart showing the process flow from when the recording of a service starts, and an insufficiency in the remaining capacity of the volume for recording the service is sensed, to when a supplementary recording is generated.

When the recording start time of the service is reached, the recording generation unit 2801 forwards, to the volume remainder insufficiency sensing unit 2802, the recording identifier, the end time, the bit rate, and the volume identifier, from among the recording information (S3501). The volume remainder insufficiency sensing unit 2802 determines whether the present time exceeds the recording end time of the service (S3502) and the process ends when the recording end time of the service is exceeded. When the recording end time of the service is not exceeded, the volume identifier is forwarded to the volume remainder detection unit 2813 of the storage manager 1704g, and the remaining capacity of the volume identified by that volume identifier is obtained (S3503). The obtained remaining capacity of the volume and the estimated required volume capacity are compared (S3504) and, when the remaining capacity of the volume is equal to or greater than the estimated required volume capacity, the recording generation manager goes on stand-by until a fixed period passes (3505).

Then, after the fixed period passes, it is again determined whether the present time exceeds the recording end time of the service (S3502) and, when not exceeded, the remaining capacity of the volume is obtained from the volume remainder detection unit 2813 of the storage manager 1704g (S3503), and it is determined whether the remaining capacity of the volume is equal to or greater than the required volume capacity (S3504). When the remaining capacity of the volume is below the required volume capacity, the recording identifier identifying the current recording of the service in the volume for which remaining capacity insufficiency has been sensed is forwarded to the remainder insufficiency handler registration unit 3301, and the calling of the remainder insufficiency handler is requested (3506).

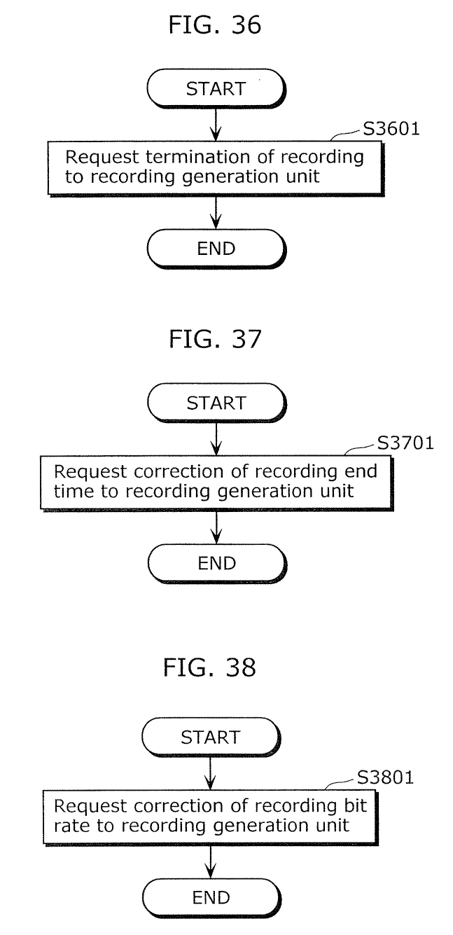

FIG. 36 is a flowchart showing the process flow in the case where the remainder insufficiency handler is called.

In the case where the recording identifier identifying the current recording of the service in the volume for which remaining capacity insufficiency has been sensed is forwarded, from the volume remainder insufficiency detection unit 2802, to the remainder insufficiency handler registration unit 3301, and the calling of the remainder insufficiency handler is requested, the remainder insufficiency handler registration unit forwards the recording identifier and calls the remainder insufficiency handler. The remainder insufficiency handler forwards the recording identifier to the recording generation unit 2801, and requests the termination of the current recording of the service, which is derived from such recording identifier (3601).

As described above, in the case where, during the recording of a service, an insufficiency in the remaining capacity of the volume for storing the service is sensed, the remainder insufficiency handler registered by the Java program is called, and the current recording of the service is terminated, so that it becomes possible to prevent the recording of the service from concluding in an incomplete state.

### Third Embodiment

Hereafter, the apparatus and the method according to the third embodiment of the present invention are described with reference to the drawings.

Since the hardware configuration, and the like, used in the third embodiment is the same as in the first embodiment, FIG. 1 to FIG. 16 shall be invoked. Since constituent elements in the diagrams have the same functions as the constituent elements having the same names and numerical references in the first embodiment, repeated description shall be omitted.

The software configuration in the third embodiment is the same as that shown in FIG. 33. Since the constituent elements aside from the recording manager 1704h have the same functions as the constituent elements having the same names and numerical references in the software configuration in the second embodiment, repeated description shall be omitted. Furthermore, since the respective data formats used in the third embodiment are the same as those shown in FIG. 20 to FIG. 22, and FIG. 29, repeated description shall be omitted.

The recording manager 1704h records the service currently being broadcast into a specified volume in the recording area 1504, at a specified bit rate, for the specified time period. The recording manager 1704h includes a recording generation unit 2801, a volume remainder insufficiency sensing unit 2802, a recording information holding unit 2803, a remainder insufficiency handler registration unit 3301 and a remainder insufficiency handler registration privilege determination unit 3302.

Since the constituent elements aside from the remainder insufficiency handler registration unit 3301, the recording generation unit 2801, and the volume remainder insufficiency sensing unit 2802 have the same functions as in the second embodiment, repeated description shall be omitted.

The remainder insufficient period handler registration unit 3301 holds a remainder insufficient period handler that is registered in advance by a privileged Java program, for responding to an insufficiency in a volume's remaining capacity, and which is invoked when insufficient remaining capacity in the volume for the current recording of the service is sensed by the volume remainder insufficiency detection unit 2802, by the forwarding, thereto, of the recording identifier identifying the current recording of the service and the bit rate and the volume remaining capacity forwarded by the recording generation unit 2801.

Based on a channel identifier, a start time, an end time, a bit rate, and a volume identifier specified by the Java program, the recording generation unit 2801 records the service identified by the channel identifier into the specified volume in the recording area 1504, at the specified bit rate, only between the specified start time and end time. Furthermore, as recording information, the specified channel identifier, the start time, the end time, the bit rate, and the volume identifier are notified to the recording information holding unit 2803 and held therein, as well as being recorded in the recording area 1504.

Furthermore, based on the recording identifier and end time specified by the remainder insufficiency handler provided for the Java program, the recording generation unit 2801 corrects (adjusts) the end time for the current recording of the service which is identified by the recording identifier.

First, since the process flow for the recording of the service identified by the channel identifier specified by the Java program is the same as in the first embodiment, repeated description shall be omitted.

Next, the process flow for the correction of the end time for the current recording of the service which is identified by the recording identifier specified by the remainder insufficiency handler provided for the Java program shall be described hereafter.

When a recording identifier and corrected end time are specified by the remainder insufficiency handler provided for the Java program and the correction of the end time for the current recording of the service identified by such recording identifier is requested, the recording generation unit 2801 uses the specified recording identifier as a key and derives the corresponding recording information from the held recording information. Subsequently, through such recording information, the end time for the current recording of the service is corrected.

Upon the recording start time of a certain service, the recording identifier, the end time, the bit rate, and the volume identifier are forwarded by the recording generation unit 2801 from among the recording information, and the volume remainder insufficiency sensing unit 2802 monitors the remaining capacity of the volume for recording the service. The volume identifier is forwarded to the volume remainder detection unit 2813 of the storage manager 1704g at fixed cycles, and the remaining capacity of the volume identified by the volume identifier is obtained. Furthermore, in the case where an insufficiency in the remaining capacity of the volume for recording the service is sensed, the recording identifier identifying the current recording of the service for which volume remaining capacity insufficiency has been sensed, the bit rate and the volume remaining capacity forwarded by the recording generation unit 2801 are forwarded to the remainder insufficiency handler registration unit 3301, and calling of the remainder insufficiency handler registered in the remainder insufficiency handler registration unit 3301 is requested.

The remainder insufficiency handler is executed by having the recording identifier identifying the current recording of the service for which volume remaining capacity insufficiency has been sensed, the bit rate and the volume remaining capacity forwarded by the recording generation unit 2801 via the volume remainder insufficiency sensing unit 2802 forwarded thereto from the remainder insufficiency handler registration unit 3301. The remainder insufficiency handler forwards the recording identifier and the recording end time to the recording generation unit 2801, and requests the correction of the end time of the recording of the service which is derived from such recording identifier. Here, the recording end time is the recoding end time estimated to be possible for the recording in the volume, calculated using the bit rate and remaining capacity of the volume.

The characteristic operation in the present embodiment in the configuration described above shall be described using the following flowchart.

Since the process flow from when the recording of a service starts, and an insufficiency in the remaining capacity of the volume for recording the service is sensed, to when a remainder insufficiency handler is called, is the same as in the second embodiment, reference shall be made to the flowchart in FIG. 35.

FIG. 37 is a flowchart showing the process flow in the case where the remainder insufficiency handler is called.

In the case where the recording identifier identifying the current recording of the service in the volume for which remaining capacity insufficiency has been sensed, and the bit rate and volume remaining capacity forwarded by the recording generation unit 2801 are forwarded from the volume remainder insufficiency detection unit 2802 to the remainder insufficiency handler registration unit 3301, and the calling of the remainder insufficiency handler is requested, the remainder insufficiency handler registration unit forwards the recording identifier, the bit rate and the volume remaining capacity and calls the remainder insufficiency handler. The remainder insufficiency handler forwards the recording identifier and the recording end time to the recording generation unit 2801, and corrects the end time for the current recording of the service which is derived from such recording identifier (3701). Here, the recording end time is the recoding end time estimated to be possible for the recording in the volume, calculated using the bit rate and remaining capacity of the volume.

As described above, in the case where, during the recording of a service, an insufficiency in the remaining capacity of the volume for storing the service is sensed, the remainder insufficiency handler registered by the Java program is called, and the end time for the current recording of the service is corrected, so that it becomes possible to prevent the recording of the service from concluding in an incomplete state while maximizing the use of the remaining capacity of the volume.

### Fourth Embodiment

Hereafter, the apparatus and the method according to the fourth embodiment of the present invention are described with reference to the drawings.

Since the hardware configuration, and the like, used in the fourth embodiment is the same as in the first embodiment, FIG. 1 to FIG. 16 shall be invoked. Since constituent elements in the diagrams have the same functions as the constituent elements having the same names and numerical references in the first embodiment, repeated description shall be omitted.

The software configuration in the fourth embodiment is the same as that shown in FIG. 33. Since the constituent elements aside from the recording manager 1704h have the same functions as the constituent elements having the same names and numerical references in the software configuration in the second embodiment, repeated description shall be omitted. Furthermore, since the respective data formats used in the fourth embodiment are the same as those shown in FIG. 20 to FIG. 22, and FIG. 29, repeated description shall be omitted.

The recording manager 1704h records the service currently being broadcast into a specified volume in the recording area 1504, at a specified bit rate, for the specified time period. The recording manager 1704h includes a recording generation unit 2801, a volume remainder insufficiency sensing unit 2802, a recording information holding unit 2803, a remainder insufficiency handler registration unit 3301 and a remainder insufficiency handler registration privilege determination unit 3302.

Since the constituent elements aside from the remainder insufficiency handler registration unit 3301, the recording generation unit 2801, and the volume remainder insufficiency sensing unit 2802 have the same functions as in the second embodiment, repeated description shall be omitted.

The remainder insufficiency handler registration unit 3301 holds a remainder insufficiency handler that is registered in advance by a privileged Java program, for responding to an insufficiency in a volume's remaining capacity, and which is invoked when insufficient remaining capacity for the current recording of the service is sensed by the volume remainder insufficiency detection unit 2802, by the forwarding, thereto, the recording identifier identifying the current recording of the service, and the end time and volume remaining capacity forwarded by the recording generation unit 2801.

Based on a channel identifier, a start time, an end time, a bit rate, and a volume identifier specified by the Java program, the recording generation unit 2801 records the service identified by the channel identifier into the specified volume in the recording area 1504, at the specified bit rate, only between the specified start time and end time. Furthermore, as recording information, the specified channel identifier, the start time, the end time, the bit rate, and the volume identifier are notified to the recording information holding unit 2803 and held therein, as well as being recorded in the recording area 1504.

Furthermore, based on the recording identifier and bit rate specified by the remainder insufficiency handler provided for the Java program, the recording generation unit 2801 corrects the bit rate for the current recording of the service which is identified by the recording identifier.

First, since the process flow for the recording of the service identified by the channel identifier specified by the Java program is the same as in the first embodiment, repeated description shall be omitted.

Next, the process flow for the correction of the bit rate for the current recording of the service identified by the recording identifier and bit rate specified by the remainder insufficiency handler provided for the Java program shall be described hereafter.

When a recording identifier and a corrected bit rate are specified by the remainder insufficiency handler provided for the Java program and the correction of the bit rate for the current recording of the service identified by such recording identifier is requested, the recording generation unit 2801 uses the specified recording identifier as a key and derives the corresponding recording information from the held recording information. Subsequently, through such recording information, the bit rate for the current recording of the service is corrected.

Upon the recording start time of a certain service, the recording identifier, the end time, the bit rate, and the volume identifier are forwarded by the recording generation unit 2801 from among the recording information, and the volume remainder insufficiency sensing unit 2802 monitors the remaining capacity of the volume for recording the service. The volume identifier is forwarded to the volume remainder detection unit 2813 of the storage manager 1704g at fixed cycles, and the remaining capacity of the volume identified by the volume identifier is obtained. Furthermore, in the case where an insufficiency in the remaining capacity of the volume for recording the service is sensed, the recording identifier identifying the current recording of the service for which volume remaining capacity insufficiency has been sensed, and the end time and volume remaining capacity forwarded by the recording generation unit 2801 is forwarded to the remainder insufficiency handler registration unit 3301, and calling of the remainder insufficiency handler registered in the remainder insufficiency handler registration unit 3301 is requested.

The remainder insufficiency handler is executed by having the recording identifier identifying the current recording of the service for which volume remaining capacity insufficiency has been sensed, and the end time and the volume remaining capacity forwarded by the recording generation unit 2801 via the volume remainder insufficiency sensing unit 2802 forwarded thereto from the remainder insufficiency handler registration unit 3301. The remainder insufficiency handler forwards the recording identifier and the bit rate to the recording generation unit 2801, and requests the correction of the bit rate of the recording of the service which is derived from such recording identifier. Here, the bit rate is the bit rate estimated to be possible for the recording in the volume, calculated using the bit rate and remaining capacity of the volume.

The characteristic operation in the present embodiment in the configuration described above shall be described using the following flowchart.

Since the process flow from when the recording of a service starts, and an insufficiency in the remaining capacity of the volume for recording the service is sensed, to when a remainder insufficiency handler is called, is the same as in the second embodiment, reference shall be made to the flowchart in FIG. 35.

FIG. 38 is a flowchart showing the process flow in the case where the remainder insufficiency handler is called.

In the case where the recording identifier identifying the current recording of the service in the volume for which remaining capacity insufficiency has been sensed, and the end time and volume remaining capacity forwarded by the recording generation unit 2801 are forwarded from the volume remainder insufficiency detection unit 2802 to the remainder insufficiency handler registration unit 3301, and the calling of the remainder insufficiency handler is requested, the remainder insufficiency handler registration unit forwards the recording identifier, the end time and the volume remaining capacity and calls the remainder insufficiency handler. The remainder insufficiency handler forwards the recording identifier and the bit rate to the recording generation unit 2801, and requests the correction of the bit rate for the current recording of the service which is derived from such recording identifier (S3801). Here, the bit rate is the bit rate estimated to be possible for the recording in the volume, calculated using the bit rate and remaining capacity of the volume.

As described above, in the case where, during the recording of a service, an insufficiency in the remaining capacity of the volume for storing the service is sensed, the remainder insufficiency handler registered by the Java program is called, and the bit rate for the current recording of the service is corrected, so that it becomes possible to prevent the recording of the service from concluding in an incomplete state while maximizing the use of the remaining capacity of the volume.

### Fifth Embodiment

Hereafter, the apparatus and the method according to the fifth embodiment of the present invention are described with reference to the drawings.

Since the hardware configuration, and the like, used in the fifth embodiment is the same as in the first embodiment, FIG. 1 to FIG. 16 shall be invoked. Since constituent elements in the diagrams have the same functions as the constituent elements having the same names and numerical references in the first embodiment, repeated description shall be omitted.

The software configuration in the fifth embodiment is the same as that shown in FIG. 33. Since the constituent elements aside from the recording manager 1704h have the same functions as the constituent elements having the same names and numerical references in the software configuration in the second embodiment, repeated description shall be omitted. Furthermore, since the respective data formats used in the fifth embodiment are the same as those shown in FIG. 20 to FIG. 22, and FIG. 29, repeated description shall be omitted.

The recording manager 1704h records the service currently being broadcast into a specified volume in the recording area 1504, at a specified bit rate, for the specified time period. The recording manager 1704h includes a recording generation unit 2801, a volume remainder insufficiency sensing unit 2802, a recording information holding unit 2803, a remainder insufficiency handler registration unit 3301 and a remainder insufficiency handler registration privilege determination unit 3302.

Since the constituent elements aside from the remainder insufficiency handler registration unit 3301, the recording generation unit 2801, and the volume remainder insufficiency sensing unit 2802 have the same functions as in the second embodiment, repeated description shall be omitted.

The remainder insufficient period handler registration unit 3301 holds a remainder insufficient period handler that is registered in advance by a privileged Java program, for responding to an insufficiency in a volume's remaining capacity, and which is invoked when insufficient remaining capacity in the volume for the current recording of the service is sensed by the volume remainder insufficiency detection unit 2802, by the forwarding, thereto, of the recording identifier identifying the current recording of the service, and the end time, the bit rate, and the volume remaining capacity forwarded by the recording generation unit 2801 via the volume remainder insufficiency sensing unit 2802.

Based on a channel identifier, a start time, an end time, a bit rate, and a volume identifier specified by the Java program, the recording generation unit 2801 records the service identified by the channel identifier into the specified volume in the recording area 1504, at the specified bit rate, only between the specified start time and end time. Furthermore, as recording information, the specified channel identifier, the start time, the end time, the bit rate, and the volume identifier are notified to the recording information holding unit 2803 and held therein, as well as being recorded in the recording area 1504.

In addition, based on the recording identifier, the start time, the end time, the bit rate, and the volume identifier specified by the remainder insufficiency handler provided for the Java program, the recording generation unit 2801 records, into the specified volume in the recording area 1504, a service which is identical to the currently-recording service identified by the recording identifier, at the specified bit rate, only between the specified start time and end time. In the same manner as the recording of the service identified by the channel identifier specified by the Java program, the channel identifier for identifying the service derived from the specified recording identifier, the start time, the end time, the bit rate, the volume identifier, and so on, are notified to the recording information holding unit 2803, as recording information, so as to be recorded therein, as well as being recording into the recording area 1504.

First, since the process flow for the recording of the service identified by the channel identifier specified by the Java program is the same as in the first embodiment, repeated description shall be omitted.

Next, the process flow for the recording of the service identified by the recording identifier, the start time, the end time, the bit rate, and the volume identifier specified by the remainder insufficiency handler provided for the Java program shall be described hereafter.

When the recording identifier, the start time, the end time, the bit rate, and the volume identifier are specified by the remainder insufficient handler provided for the Java program, the recording generation unit 2801 uses the specified recording identifier as a key and derives the corresponding recording information. Then, according to such recording information, the service currently being recorded is recorded into the specified volume in the recording area 1504, at the specified bit rate, only between the specified start time and end time.

However, unlike the recording of the service identified by the channel identifier specified by the Java program, the recording generation unit 2801 does not forward, from among the recording information, the recording identifier, the end time, the bit rate, and the volume identifier to the volume remainder insufficiency sensing unit 2802 even when the start time is reached, in other words, the recording generation unit 2801 does not cause the monitoring of the remaining capacity of the volume for recording the service.

Since the succeeding process flow is the same as in the recording of the service identified by the channel identifier specified by the Java program, description shall be omitted here.

Upon the recording start time of a certain service, the recording identifier, the end time, the bit rate, and the volume identifier are forwarded by the recording generation unit 2801 from among the recording information, and the volume remainder insufficiency sensing unit 2802 monitors the remaining capacity of the volume for recording the service. The volume identifier is forwarded to the volume remainder detection unit 2813 of the storage manager 1704g at fixed cycles, and the remaining capacity of the volume identified by the volume identifier is obtained. Furthermore, in the case where an insufficiency in the remaining capacity of the volume for recording the service is sensed, the recording identifier identifying the current recording of the service for which volume remaining capacity insufficiency has been sensed is forwarded to the remainder insufficiency handler registration unit 3301, and calling of the remainder insufficiency handler registered in the remainder insufficiency handler registration unit 3301 is requested.

The remainder insufficiency handler is executed by having the recording identifier identifying the current recording of the service for which volume remaining capacity insufficiency has been sensed, the bit rate and the volume remaining capacity forwarded by the recording generation unit 2801 via the volume remainder insufficiency sensing unit 2802 forwarded thereto from the remainder insufficiency handler registration unit 3301. The remainder insufficiency handler forwards, to the recording generation unit 2801, the recording identifier, the recording start time, the recording end time, the bit rate, and the volume identifier generated by the remainder insufficiency handler, and requests for the generation of a supplementary recording. Here, the recording start time is the time at which the remaining capacity in the volume runs out. Furthermore, the recording end time, or the bit rate is set so as to allow the recording in the generated supplementary volume. As such, there is a possibility that these are different from the recording end time or bit rate forwarded from the recording generation unit 2801 via the volume remainder insufficiency sensing unit 2802.

The characteristic operation in the present embodiment in the configuration described above shall be described using the following flowchart.

Since the process flow from when the recording of a service starts, and an insufficiency in the remaining capacity of the volume for recording the service is sensed, to when a remainder insufficiency handler is called, is the same as in the second embodiment, reference shall be made to the flowchart in FIG. 35.

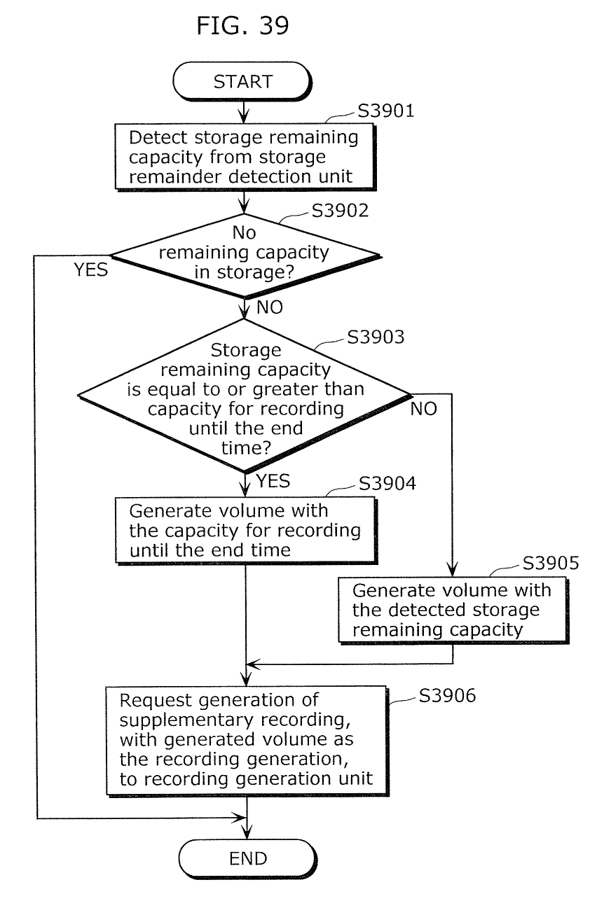

FIG. 39 is a flowchart showing the process flow in the case where the remainder insufficiency handler is called.

In the case where the recording identifier identifying the current recording of the service, in the volume for which remaining capacity insufficiency has been sensed, and the bit rate and volume remaining capacity forwarded by the recording generation unit 2801 are forwarded from the volume remainder insufficiency detection unit 2802 to the remainder insufficiency handler registration unit 3301, and the calling of the remainder insufficiency handler is requested, the remainder insufficiency handler registration unit forwards the recording identifier, the bit rate and the volume remaining capacity and calls the remainder insufficiency handler. The remainder insufficiency handler obtains, from the storage remainder detection unit 2814 of the storage manager 1704g, the capacity of the storage to which a volume is not assigned (S3901).

First, it is determined whether there is a remaining capacity in the capacity of the storage obtained from the storage remainder detection unit 2814 (S3902). In the case where there is no remaining capacity in the obtained storage capacity, the supplementary volume generation fails, and the process ends. In the case where there is a remaining capacity in the obtained storage capacity, it is determined whether the storage remaining capacity obtained from the storage remainder detection unit 2814 is equal to or greater than the volume capacity which is estimated will be insufficient up to the end of the recording of the service, and which is calculated using the end time, the bit rate, and the remaining capacity of the volume (S3903). In the case where the obtained storage remaining capacity is equal to or greater than the insufficient volume capacity, the insufficient volume capacity and the prescribed volume name are specified, and generation of a volume is requested to the volume generation unit 2811 (S3904).

However, in the case where the remaining capacity in the obtained storage is below the required supplementary volume capacity, the storage remaining capacity and the prescribed volume name obtained from the storage remainder detection unit 2814 is specified and generation of a volume is requested to the volume generation unit 2811 (S3905). When the volume generation is successful, a volume identifier generated by the volume generation unit 2811 is returned. In the case where the generation of a volume is successful, the recording identifier, recording start time, the recording end time, the bit rate, and the generated volume identifier forwarded by the recording generation 2801 via the volume remainder sensing unit 2802 is forwarded to the recording generation unit 2801, and generation of a supplementary recording is requested (S3906).

Here, the recording start time is the time at which the remaining capacity of the currently recorded volume runs out. Furthermore, the recording end time, or the bit rate is set so as to allow the recording in the generated supplementary volume. As such, there is a possibility that these are different from the recording end time or bit rate forwarded from the recording generation unit 2801 via the volume remainder insufficiency sensing unit 2802.

As described above, in the case where, during the recording of a service, an insufficiency in the remaining capacity of the volume for storing the service is sensed, the remainder insufficiency handler registered by the Java program is called, and the a volume for the capacity which is estimated will be insufficient until the end of the recording of the service is generated, and the current recording of the service is transferred, so that it becomes possible to maximize the use of the remaining portion of the storage, and complete the recording of the service.

### Sixth Embodiment

Hereafter, the apparatus and the method according to the sixth embodiment of the present invention are described with reference to the drawings.

Since the hardware configuration, and the like, used in the sixth embodiment is the same as in the first embodiment, FIG. 1 to FIG. 16 shall be invoked. Since constituent elements in the diagrams have the same functions as the constituent elements having the same names and numerical references in the first embodiment, repeated description shall be omitted. Furthermore, since the respective data formats used in the sixth embodiment are the same as those shown in FIG. 20 to FIG. 22, and FIG. 29, repeated description shall be omitted.

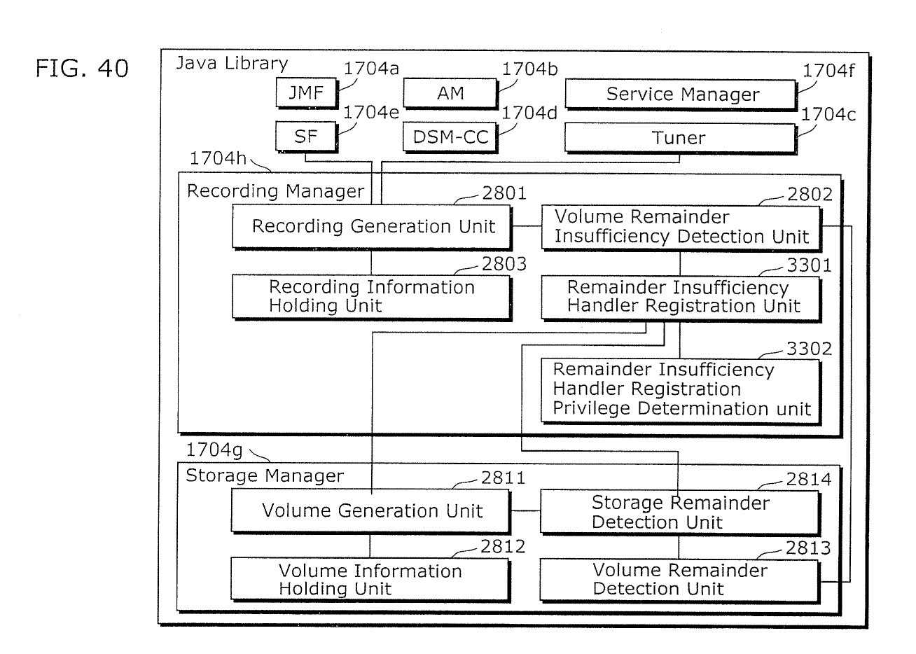

FIG. 40 is a diagram showing a detailed configuration of the storage manager 1704g and the recording manager 1704h of the Java library 1704. Since the constituent elements aside from the storage manager 1704g and the recording manager 1704h have the same functions as the constituent elements having the same names and numerical references in the software configuration in the second embodiment, repeated description shall be omitted.

A storage manager 1704g manages a storage, in other words, the recording area 1504 by dividing it into one or a plurality of units called a volume. The storage manager 1704g includes a volume generation unit 2811, a volume information holding unit 2812, a volume remainder detection unit 2813, and a storage remainder detection unit 2814.

Since the constituent elements aside from the volume generation unit 2811 and the storage remainder detection unit 2814 have the same functions as in the fifth embodiment, repeated description shall be omitted.

The volume generation unit 2811 generates a volume in the recording area 1504, based on a volume name and volume capacity specified by a Java program or the remainder insufficiency handler registration unit 3301. For example, in the case where a volume name of “MEDIA” and a volume capacity of “10240” are specified, a 10240-kilobyte volume “MEDIA” is generated in the recording area 1504. Volume generation fails when the volume generation unit 2811 obtains, from the storage remainder detection unit 2814, the remaining capacity in the storage, in other words, the recording area 1504, and there is insufficient available capacity; or when the volume generation unit 2811 obtains, from the volume information holding unit 2812, volume information already existing in the recording area 1504, and a volume having the same name already exists. When volume generation is successful, information such as a volume identifier for identifying the volume, the volume name, the volume capacity, and so on, are notified to the volume information holding unit 2812, as volume information, and held therein, as well as recorded in the recording area 1504.

The process flow up to the generation of a volume specified by a Java program or the remainder insufficiency handler registration unit 3301 is shown in FIG. 30.

A volume name and a volume capacity are specified by the Java program or the remainder insufficiency handler registration unit 3301, and volume generation is requested to the volume generation unit 2811. The volume generation unit 2811 obtains the remaining capacity in the storage from the storage remainder detection unit 2814, and judges whether there is sufficient remaining capacity in the storage for the volume generation. In the case where the remaining capacity is not sufficient, the volume generation fails. In the case where the remaining capacity is sufficient, the volume generation unit 2811 obtains the volume information already existing in the storage from the volume information holding unit 2812, and judges whether there is a volume with the same name exists in the storage. In the case where a volume with the same name already exists in the storage, the volume generation fails. In the case where a volume with the same name does not exist in the storage, the volume is generated, and a volume identifier for identifying the volume is assigned. Information such as the volume identifier, the volume name, the volume capacity, and so on, are notified to the volume information holding unit 2812, as volume information, and held therein.

Based on an inquiry from the Java program, the volume generation unit 2811, or the remainder insufficiency handler registration unit 3301, the storage remainder detection unit 2814 returns the capacity of the storage, in other words, the recording area 1504, to which a volume is not assigned at that point in time.

The recording manager 1704h records the service currently being broadcast into a specified volume in the recording area 1504, at a specified bit rate, for the specified time period. The recording manager 1704h includes a recording generation unit 2801, a volume remainder insufficiency sensing unit 2802, a recording information holding unit 2803, a remainder insufficiency handler registration unit 3301 and a remainder insufficiency handler registration privilege determination unit 3302.

Since the constituent elements aside from the remainder insufficiency handler registration unit 3301 and the recording generation unit 2801 have the same functions as in the fifth embodiment, repeated description shall be omitted.

The remainder insufficiency handler registration unit 3301 holds a remainder insufficiency handler that is registered in advance by a privileged Java program, for responding to an insufficiency in a volume's remaining capacity, and which is invoked when insufficient remaining capacity for the current recording of the service is sensed by the volume remainder insufficiency detection unit 2802, by the forwarding, thereto, of the recording identifier identifying the current recording of the service, and end time and bit rate forwarded by the recording generation unit 2801 via the volume remainder insufficiency sensing unit 2802.

In the case where a remainder insufficiency handler held in the remainder insufficiency handler registration unit 3301 is called, the remainder insufficiency handler registration unit 3301 changes the response to the volume remaining capacity insufficiency according to the returned value from the remainder insufficiency handler.

When the returned value from the remainder insufficiency handler is “STOP_RECORDING”, the remainder insufficiency handler registration unit 3301 specifies, to the recording generation unit 2801, the recording identifier identifying the recording of the service for which volume remainder insufficiency has been sensed, and causes the recording of the service to be stopped.

When the returned value from the remainder insufficiency handler is “TIME_FORWARD”, the remainder insufficiency handler registration unit 3301 specifies, to the recording generation unit 2801, a corrected recording end time and the recording identifier identifying the recording of the service for which volume remainder insufficiency has been sensed, and causes the end time for the recording of the service to be corrected. Here, the recording end time is the recoding end time for the estimated possible recording for the volume, calculated using the bit rate and remaining capacity of the volume.

When the returned value from the remainder insufficiency handler is “RATE_DOWN”, the remainder insufficiency handler registration unit 3301 specifies, to the recording generation unit 2801, a corrected bit rate and the recording identifier identifying the recording of the service for which volume remainder insufficiency has been sensed, and causes the bit rate for the recording of the service to be corrected. Here, the bit rate is the bit rate estimated to be possible for the recording in the volume, calculated using the bit rate and remaining capacity of the volume.

When the returned value from the remainder insufficiency handler is “CREATE_VOLUME”, the remainder insufficiency handler registration unit 3301 obtains, from the storage remainder detection unit 2814 of the storage manager 1704g, the capacity of a storage to which a volume is not assigned. First, it is determined whether there is remaining capacity in the storage capacity obtained from the storage remainder detection unit 2814. In the case where there is no remaining capacity in the obtained storage capacity, the supplementary volume generation fails, and the process ends. In the case where there is a remaining capacity in the obtained storage capacity, it is determined whether the storage remaining capacity obtained from the storage remainder detection unit 2814 is equal to or greater than the volume capacity which is estimated will be insufficient up to the end of the recording of the service, and which is calculated using the end time, the bit rate, and the remaining capacity of the volume.

In the case where the remaining capacity in the obtained storage is equal to or greater than the insufficient volume capacity, the remainder insufficiency handler registration unit 3301 specifies the insufficient volume capacity and prescribed volume name, and requests the generation of a volume to the volume generation unit 2811. However, in the case where the obtained remaining capacity of the storage is below the insufficient volume capacity, the remainder insufficiency handler registration unit 3301 specifies the remaining capacity of the storage and the prescribed volume name obtained from the storage remainder detection unit 2814, and requests the generation of a volume to the volume generation unit 2811. When the volume generation is successful, a volume identifier generated by the volume generation unit 2811 is returned.

In the case where the generation of supplementary volume is successful, the remainder insufficiency handler registration unit 3301 forwards, to the recording generation unit 2801, the recording identifier identifying the recording of the service for which volume remaining capacity insufficiency is sensed, recording start time, a recording end time, a bit rate, and the generated volume identifier, and requests the generation of a supplementary recording. Here, the recording start time is the time at which the remaining capacity in the volume runs out. Furthermore, the recording end time, or the bit rate is set so as to allow the recording in the generated supplementary volume. As such, there is a possibility that these are different from the recording end time or bit rate forwarded from the recording generation unit 2801 via the volume remainder insufficiency sensing unit 2802.

Based on a channel identifier, a start time, an end time, a bit rate, and a volume identifier specified by the Java program, the recording generation unit 2801 records the service identified by the channel identifier into the specified volume in the recording area 1504, at the specified bit rate, only between the specified start time and end time. Furthermore, as recording information, the specified channel identifier, the start time, the end time, the bit rate, and the volume identifier are notified to the recording information holding unit 2803 and held therein, as well as being recorded in the recording area 1504.

First, since the process flow for the recording of the service identified by the channel identifier specified by the Java program is the same as in the first embodiment, repeated description shall be omitted.

Furthermore, based on the recording identifier specified by the remainder insufficiency handler registration unit 3301, the recording generation unit 2801 terminates the current recording of the service identified by the recording identifier.

The process flow for the termination of the current recording of the service identified by the recording identifier specified by the remainder insufficiency handler registration unit 3301 shall be described hereafter.

When a recording identifier is specified by the remainder insufficiency handler registration unit 3301 and the termination of the current recording of the service identified by such recording identifier is requested, the recording generation unit 2801 uses the specified recording identifier as a key and derives the corresponding recording information from the held recording information. Subsequently, through such recording information, the current recording of the service is terminated. Specifically, the recording generation unit 2801 stops the tuning operation of the Tuner 1704c, and causes the writing of the MPEG-2 transport stream to the specified volume in the recording area 1504 to end. In addition, a recording information management table as shown in FIG. 21 is created as management information of the MPEG-2 transport stream recorded earlier.

Furthermore, based on the recording identifier and end time specified by the remainder insufficiency handler registration unit 3301, the recording generation unit 2801 corrects the end time for the current recording of the service identified by the recording identifier.

The process flow for the correction of the end time for the current recording of the service identified by the recording identifier and the recording end time specified by the remainder insufficiency handler registration unit 3301 shall be described hereafter.

When a recording identifier and corrected end time are specified and the correction of the end time for the current recording of the service identified by such recording identifier is requested by the remainder insufficient period handler registration unit 3301, the recording generation unit 2801 uses the specified recording identifier as a key and derives the corresponding recording information from the held recording information. Subsequently, through such recording information, the end time for the current recording of the service is corrected.

Furthermore, based on the recording identifier and bit rate specified by the remainder insufficiency handler registration unit 3301, the recording generation unit 2801 corrects the bit rate for the current recording of the service identified by the recording identifier.

The process flow for the correction of the bit rate for the current recording of the service identified by the recording identifier and bit rate specified by the remainder insufficiency handler registration unit 3301 shall be described hereafter.

When a recording identifier and a corrected bit rate are specified by the remainder insufficiency handler registration unit 3301 and the correction of the bit rate for the current recording of the service identified by such recording identifier is requested, the recording generation unit 2801 uses the specified recording identifier as a key and derives the corresponding recording information from the held recording information. Subsequently, through such recording information, the bit rate for the current recording of the service is corrected.

In addition, based on the recording identifier, the start time, the end time, the bit rate, and the volume identifier specified by the remainder insufficiency handler registration unit 3301, the recording generation unit 2801 records, into the specified volume in the recording area 1504, a service which is identical to the currently-recording service identified by the recording identifier, at the specified bit rate, only between the specified start time and end time. In the same manner as the recording of the service identified by the channel identifier specified by the Java program, the channel identifier for identifying the service derived from the specified recording identifier, the start time, the end time, the bit rate, the volume identifier, and so on, are notified to the recording information holding unit 2803, as recording information, so as to be recorded therein, as well as being recording into the recording area 1504.

Next, the process flow for the recording of the service identified by the recording identifier specified by the remainder insufficiency handler registration unit 3301 shall be described hereafter.

When the recording identifier, the start time, the end time, the bit rate, and the volume identifier are specified by the remainder insufficiency handler registration unit 3301, the recording generation unit 2801 uses the specified recording identifier as a key and derives the corresponding recording information. Then, according to such recording information, the service currently being recorded is recorded into the specified volume in the recording area 1504, at the specified bit rate, only between the specified start time and end time.

However, unlike the recording of the service identified by the channel identifier specified by the Java program, the recording generation unit 2801 does not forward, from among the recording information, the recording identifier, the end time, the bit rate, and the volume identifier to the volume remainder insufficiency sensing unit 2802 even when the start time is reached, in other words, the recording generation unit 2801 does not cause the monitoring of the remaining capacity of the volume for recording the service.

Since the succeeding process flow is the same as in the recording of the service identified by the channel identifier specified by the Java program, description shall be omitted here.

As in the aforementioned manner, by calling the remainder insufficiency handler registered by the Java program and changing the remaining capacity insufficiency response according to the returned value from the remainder insufficiency handler in the case where an insufficiency in the remaining capacity of the volume for recording a service is sensed, it becomes possible to carry out the appropriate countermeasure even when an insufficiency in the remaining capacity of the volume occurs during the recording of the service.

### Seventh Embodiment

Hereafter, an apparatus and a method according to the seventh embodiment of the present invention are described with reference to the drawings.

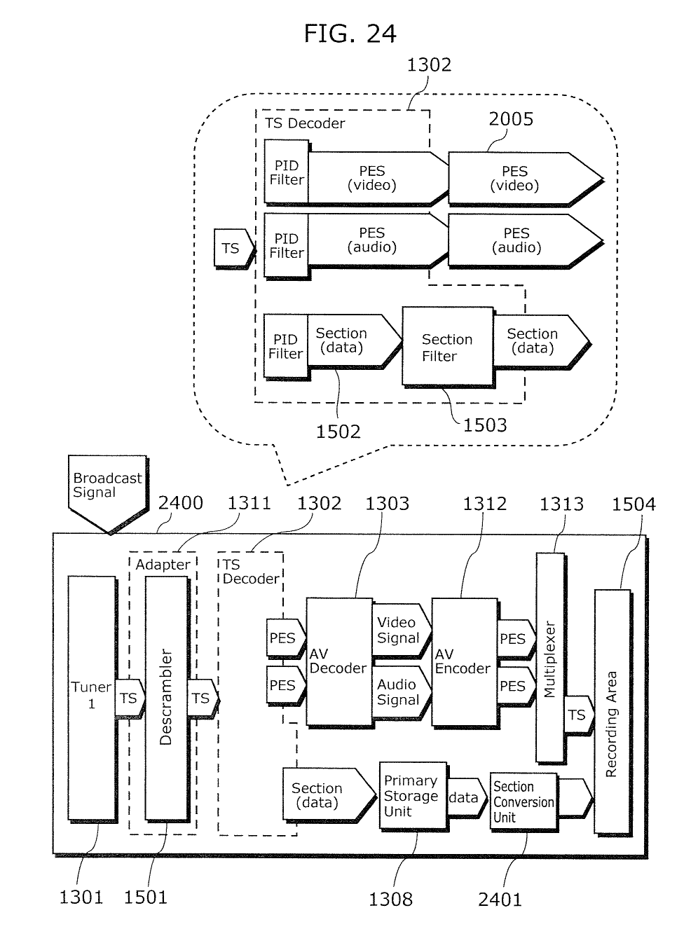

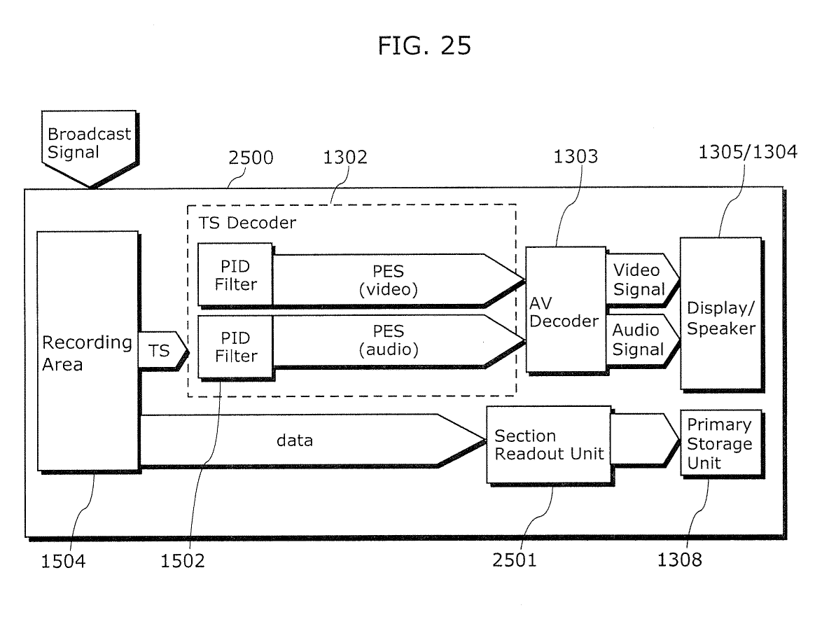

The seventh embodiment provides a different hardware configuration embodiment for realizing the first embodiment. The hardware configuration and the like used in the seventh embodiment is shown in FIG. 24 and FIG. 25.

FIG. 24 shows a conceptual rendering which expresses the physical connection sequence, processing details, and input/output data format of each device during recording of the service. Constituent elements in the diagram having identical numerical references as in FIG. 15 have already been described in the first embodiment, and therefore descriptions are omitted. As opposed to FIG. 15, with the hardware configuration shown in FIG. 24, after passing through the primary storage unit 1308, the section filtered by the TS decoder 1302 is recorded to the recording area 1504 without going through the multiplexer. Here, the recording method when recording the section into the recording area 1504 differs depending on a format of the section.

In the case of a file system recorded within an MPEG-2 transport stream in a DSM-CC file system format, such file system is converted into a file system format unique to the recording area 1504, which is in turn unique to a terminal, and recorded into the recording area 1504.

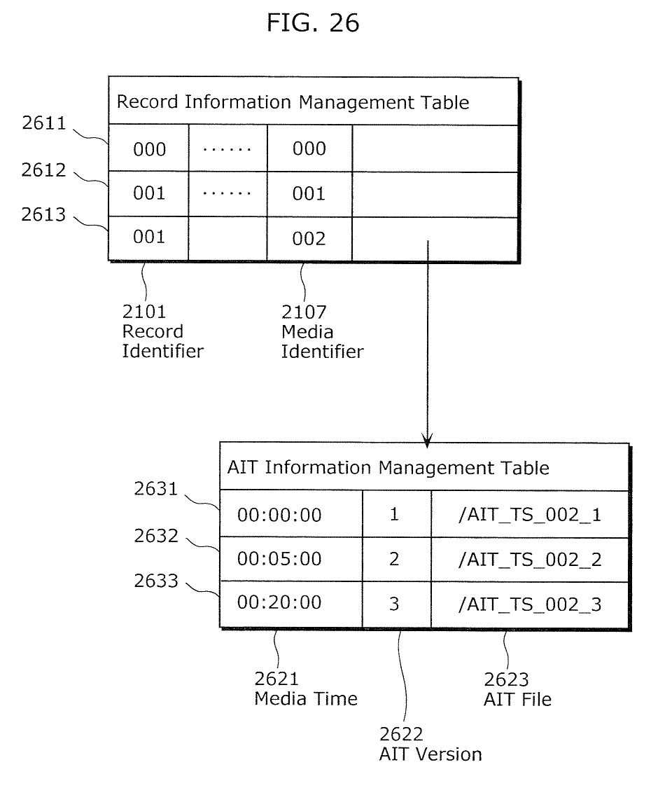

In addition, an AIT is converted to an expanded recording information management table format, as in FIG. 26, and records the AIT into the recording area 1504. The recording information management table shown in FIG. 26 is an expanded version of the recording information management table shown in FIG. 21; items identified with the same numerical references in both tables have the same meaning as those in the recording information management table shown in FIG. 21, thus descriptions are omitted.

Each of rows 2611 and 2613 shows recording information for one service. Each of the rows 2611, 2613 have a record identifier 2101, a channel identifier 2102, a program number 2103, a service recording start time 2104, a service recording end time 2105, a service recording bit rate 2106, a media identifier 2107, and a reference to an AIT information management table. The AIT information management table has a media time 2621 and an AIT version 2622 corresponding thereto. The media time 2621 is the time at the time of reproduction of the corresponding MPEG-2 transport stream is reproduced, and shows a position in the corresponding MPEG-2 transport stream. An AIT version number 2622 corresponds to an AIT version 2200 in FIG. 22.

For example, recording information of the service that has a record identifier 2101 of “001” has a media identifier 2107 of “0010”, and at the media time 2621 of “00:00:00” in the referred AIT information management table, the corresponding AIT version 2622 is “1”. In the same manner, the AIT version 2622 corresponding to the media time 2621 of “00:05:00” is “2”, and the AIT version 2622 corresponding to the media time 2621 of “00:20:00” is “3”. At the time of reproduction of the service that has a channel identifier 2601 of “0010”, referring to the recording information management table, the MPEG-2 transport stream that is multiplexed with the video and audio specified by the media identifier 2107 of “001” is reproduced; in addition, referring to the AIT information management table, when the media time 2621 reaches “00:00:000”, control which causes the Java program to start up or terminate is performed in accordance with the AIT with an AIT version 2622 of “1”.

In a similar manner, the control which causes the Java program to start up or terminate is performed in accordance with the AIT with an AIT version 2622 of “2” when the media time 2621 reaches “00:05:00”, and in accordance with the AIT with an AIT version number 2622 of “3” when the media time 2621 reaches “00:20:00”. The actual AIT is converted, as a binary file in private section format, into the file system format unique to the recording area 1504, which is in turn unique to a terminal, and is recorded into the recording area 1504. The recorded file is given a unique file name by which it can be uniquely identified, and which is recorded in the recording information administration table as an AIT file name 2623.

In an actual broadcast signal, AITs with the same AIT version are repeatedly transmitted any number of times, but in the present embodiment, by detecting a change in the received AIT version, only the first AIT that is updated at that point in time is recorded into the recording area 1504.

FIG. 25 shows a conceptual rendering which expresses the physical connection sequence, processing details, and input/output data format of each device during recording of the service. Constituent elements in the diagram that have identical numerical references as in FIG. 16 have already been described in the first embodiment, and therefore descriptions are omitted.

As opposed to FIG. 16, with the hardware configuration in FIG. 25, the section recorded in the recording area 1504 is read into the primary storage without passing through the TS decoder. The media time that corresponds to the present reproduction time of the MPEG-2 transport stream read out from the recording area is searched from the recording information management table, and the AIT and DSM-CC file system corresponding to that media time is read from a file.

Here, the case where a service corresponding to a channel identifier “001” is reproduced from the recording area 1504 according to the AIT shown in FIG. 22 and the recording information management table shown in FIG. 26 is given as an example.

When the service corresponding to the media identifier “001” is specified as the service to be reproduced, audio/video belonging to the service, and a Java program belonging to the service are reproduced and started up respectively, in the reproduction of a service as previously described.

In the case where the media time for starting the recording is not specified, the reproduction is started from the point where the media time 2621 is “00:00:00”. In other words, as the video/audio, the MPEG-2 transport stream having the media identifier “001” corresponding to the recording identifier 2101 of “001” is recorded from the media time 2621 of “00:00:00”. Referring to the AIT information management table, since the AIT version 2622 corresponding to the media time 2621 “00:00:00” is “1”, the AIT having an AIT version 2200 of “1” is read from the file. Based on the details of the AIT, the Java program corresponding to the program name 2204 having the control information of “autostart” is started up.

Next, the reproduction of the service is continued and, when the position at which the MPEG-2 transport stream corresponding to the media identifier “001” is being reproduced becomes the media time 2621 “00:05:00”, the AIT information table is referred to, and since the AIT version 2622 corresponding to the media time 2621 of “00:05:00” is “2”, the Java program corresponding to the program name 2204 having the control information of “autostart” is started up based on the AIT having an AIT version 2200 of “2”, and the Java program corresponding to the program name 2204 having the control information of “destroy” or “kill” is terminated. Here, referring to FIG. 22, the program name having the control information 2202 of “destroy” is “/b/MusicXlet”, and the program name having the control information 2202 of “kill” is “/z/StudyXlet”. Therefore, at the media time 2621 “00:05:00”, when the Java programs corresponding to such program names are being executed, such Java programs are terminated.

Next, the reproduction of the service is continued and, when the position at which the MPEG-2 transport stream corresponding to the media identifier 2107 “001” is being reproduced becomes the media time 2621 “00:20:00”, the AIT information table is referred to, and since the AIT version 2622 corresponding to the media time 2621 of “00:20:00” is “3”, the Java program corresponding to the program name 2204 having the control information of “autostart” is started up based on the AIT having an AIT version 2200 of “3”, and the Java program corresponding to the program name 2204 having the control information of “destroy” or “kill” is terminated.

In the aforementioned manner, service reproduction by combining the video and audio multiplexed by the multiplexer and the separate DSMCC file system and AIT file which are recorded in different formats becomes possible. Accordingly, since it becomes sufficient to have only the single recording during updating for the DSMCC file systems and AITs repeatedly sent in a broadcast, it becomes possible to minimize the consumption of storage capacity in the recording area.

The several embodiments described above indicate embodiments of the present invention, but other embodiments can be considered as long as the intent of the present invention is realized.

In the embodiments, a configuration for a cable system has been shown, but the present invention is not dependent on the type of broadcast system. For example, the present invention can easily be applied to a satellite system, a ground wave system, or a TV show distribution system that uses an IP network. In addition, as the present invention has no direct relationship with the differences between each broadcast system, the present invention can be applied to an arbitrary transmission medium regardless of the broadcast system. The present invention also has no dependency on a wired or wireless system.

It is not always necessary for the AV decoder to decode video and audio at the same time. The present invention can be implemented even with a configuration having a separate video encoder and audio decoder. In addition, it is acceptable for the AV decoder to have a decode function for data such as closed captioning and the like. The audio signal and video signal decoded by the AV decoder may be scrambled at any stage up until being stored in the recording area 1504.

Although the embodiments show examples which introduce an adapter that controls the conditional access system, an adapter is not necessarily required to implement the present invention. The adapter may be of any format, and a configuration without the adapter is also possible. In such a case, in FIG. 15, the MPEG-2 transport stream from the tuner is inputted directly into the TS decoder. The present invention is applicable is such a case as well. In addition, descrambling by the adapter does not need to be carried out before the TS decoder. A configuration which uses the adapter in an arbitrary position for descrambling can be easily implemented, and the present invention is applicable in such a case as well.

The encoding format into which the AV encoder encodes the audio and video signal may be an arbitrary format. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of the display and speaker.

The present invention can be implemented even if the CPU itself is a system which jointly performs all or a part of the processes of TS decoding, AV decoding, AV encoding, and multiplexing.

As a format for recording the service, the MPEG-2 transport stream can also be recorded directly into the recording area after being outputted from the tuner, without going through the TS decoder; or, a translator for converting the format of the MPEG-2 transport stream may be installed and the format of the MPEG-2 transport stream from the tuner can be converted, and the result recorded into the recording area. The present invention can be implemented regardless of the service recording method that is used.

Some Java virtual machines translate the byte code into an execution format which can be interpreted by the CPU and pass the result to the CPU, which executes it; the present invention is applicable in such a case as well.

In the present embodiment, the case where there is a single storage, in other words, the recording area 1504, is given but there can also be a plurality. In such case, a storage identifier for identifying the storage is, in addition, also specified to the volume generation unit 2811, the volume information holding unit 2812, the volume remainder detection unit 2813, and the storage remainder detection unit 2814.

The above embodiments describe a method for implementation regarding the AIT in which the transport stream is obtained from in-band; however, the method for referring to the Java program which the AM shall execute is not limited to that which uses the AIT. In OCAP which is expected to the used in the United States cable system, the XAIT describing the reference information of an application program in the OOB described in FIG. 3 is used. In addition, methods such as starting a program pre-recorded in the ROM, starting a program downloaded and recorded in the secondary storage unit, and so on can be considered.

According to the recording and reproduction apparatus and the recording and reproduction method in the present invention, when, during the recording of a broadcast signal, an insufficiency in the remaining capacity of the unit for recording the broadcast signal is sensed, a registered remainder insufficiency handler is called, and responding to the insufficiency in the remaining capacity of the volume changes depending on the returned value of the remainder insufficiency handler. Therefore, it becomes possible for the remainder insufficiency handler to select and execute a predetermined response, according to such returned value.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

In the recording apparatus (recording and reproduction apparatus and the recording and reproduction method) according to the present invention, when, at the time of service recording, an insufficiency in the remaining capacity in the volume for recording the service is sensed, a volume is generated in the surplus portion of the storage, and the portion of the service that cannot be recorded is recorded in the supplementary volume. Therefore, it becomes possible to utilize the surplus portion of the storage and complete the recording of the service, and thus, the possibility for use in consumer devices according to the recording and reproduction apparatus is high. For example, the present invention is can be used in a cable STB, a digital TV, and the like. Furthermore, the present invention is also applicable in devices with a broadcast receiving function; for example, a device such as a cellular phone and the like.

1. A recording apparatus that records data included in a broadcast signal, said recording apparatus comprising:
a recording generation unit operable to record the data included in the broadcast signal into a unit-region, the unit-region being a predetermined capacity within a recording area;
a volume remainder detection unit operable to detect a remaining capacity available for recording in the unit-region;
a volume remainder insufficiency sensing unit operable to sense that the remaining capacity available for recording in the unit-region is below a predetermined capacity, the remaining capacity being detected by said volume remainder detection unit;
a remainder insufficiency handler which is called when said volume remainder insufficiency sensing unit senses that the remaining capacity available for recording in the unit-region being used for the recording, is below the predetermined capacity; and
a remainder insufficiency handler registration unit operable to register the remainder insufficiency handler,
wherein said remainder insufficiency handler registered in said remainder insufficiency handler registration unit is called when said volume remainder insufficiency sensing unit senses that the remaining capacity available for recording in the unit-region is below the predetermined capacity.

2. The recording apparatus according to claim 1,
wherein said remainder insufficiency handler registration unit is operable to register said remainder insufficiency handler upon being called based on information specified by an application program which is extracted from data included in a broadcast signal and executed, the information identifying the unit-region.

3. The recording apparatus according to claim 1,
wherein said remainder insufficiency handler is operable to terminate the recording of the data included in the broadcast signal into the unit-region.

4. The recording apparatus according to claim 1,
wherein said remainder insufficiency handler is operable to adjust a scheduled end time for the recording of the data included in the broadcast signal into the unit-region.

5. The recording apparatus according to claim 1,
wherein said remainder insufficiency handler is operable to adjust a bit rate for the recording of the data included in the broadcast signal into the unit-region.

6. The recording apparatus according to claim 1,
wherein said remainder insufficiency handler is operable to generate, within the recording area, a new unit-region other than the unit-region being used for the recording, and to record the data included in the broadcast signal into the new unit-region.

7. The recording apparatus according to claim 1,
wherein said remainder insufficiency handler is operable to generate, within the recording area, a new region having a different capacity from the unit-region being used for the recording, and to record the data included in the broadcast signal into the new region.

8. The recording apparatus according to claim 1,
wherein the unit-region has a minimum capacity necessary for recording the data included in the broadcast signal at a specific bit rate.

9. A recording apparatus that records data included in a broadcast signal, said recording apparatus comprising:
a recording generation unit operable to record the data included in the broadcast signal into a unit-region for a specific period of time, the unit-region being a predetermined capacity within a recording area;
a volume remainder detection unit operable to detect a remaining capacity available for recording in the unit-region;
a volume remainder insufficiency sensing unit operable to sense that the remaining capacity available for recording in the unit-region is below a minimum capacity necessary for recording the broadcast signal for the specific period of time, the remaining capacity being detected by said volume remainder detection unit; and
a supplementary volume generation unit operable to generate a new unit-region within the recording area, and to record the data included in the broadcast signal into the new unit-region.

10. The recording apparatus according to claim 2,
wherein said remainder insufficiency handler is operable to terminate the recording of the data included in the broadcast signal into the unit-region.

11. The recording apparatus according to claim 2,
wherein said remainder insufficiency handler is operable to adjust a scheduled end time for the recording of the data included in the broadcast signal into the unit-region.

12. The recording apparatus according to claim 2,
wherein said remainder insufficiency handler is operable to adjust a bit rate for the recording of the data included in the broadcast signal into the unit-region.

13. The recording apparatus according to claim 2,
wherein said remainder insufficiency handler is operable to generate, within the recording area, a new unit-region other than the unit-region being used for the recording, and to record the data included in the broadcast signal into the new unit-region.

14. The recording apparatus according to claim 2,
wherein said remainder insufficiency handler is operable to generate, within the recording area, a new region having a different capacity from the unit-region being used for the recording, and to record the data included in the broadcast signal into the new region.

15. The recording apparatus according to claim 2,
wherein the unit-region has a minimum capacity necessary for recording the data included in the broadcast signal at a specific bit rate.
